(19) United States
(12) Patent Application Publication
(10) Pub. No.: US 2024/0278698 A1
(43) Pub. Date: Aug. 22, 2024

(54) CONVEYANCE SEAT

(71) Applicant: TS TECH CO., LTD., Asaka-shi, Saitama (JP)

(72) Inventors: Kensuke MIZOI, Tochigi (JP); Hiroshi TAKANOHASHI, Tochigi (JP); Akira MIYOSHI, Tochigi (JP)

(21) Appl. No.: 18/571,628

(22) PCT Filed: Jun. 17, 2022
(86) PCT No.: PCT/JP2022/024382

§ 371 Date: Dec. 18, 2023

Related U.S. Application Data
(60) Provisional application No. 63/212,366, filed on Jun. 18, 2021.
(60) Provisional application No. 63/301,175, filed on Jan. 20, 2022.

(30) Foreign Application Priority Data
Mar. 31, 2022 (JP) 2022-059754
Mar. 31, 2022 (JP) 2022-059755
Mar. 31, 2022 (JP) 2022-059756

(51) Int. Cl. B60N 2/64; B60N 2/00; B60N 2/68; B60N 2/70

(52) U.S. Cl. CPC B60N 2/646; B60N 2/0031; B60N 2/68; B60N 2/7047

(57) ABSTRACT

A conveyance seat includes a seat cushion including a cushion frame serving as a skeleton. The cushion frame includes a body frame made of a frame-shaped body, and a support member bridging one portion and the other portion of the body frame in a predetermined direction and supporting a seated occupant. The support member is provided with a central support portion supporting the seated occupant, side support portions provided at positions outside the central support portion in a seat width direction and extending outward in the seat width direction while inclining, and a shape-holding member extending along outer edge portions of the side support portions and bridging the one portion and the other position of the body frame.

### TECHNICAL FIELD

The present invention relates to a conveyance seat, particularly to a conveyance seat including a seat frame serving as a skeleton.

### BACKGROUND ART

In the related art, a conveyance seat including a cushion frame serving as a skeleton has been known.

The cushion frame includes, for example, side frames disposed on the right and left sides in a seat width direction; a front connecting frame connecting front portions of the right and left side frames; a rear connecting frame connecting rear portions of the right and left side frames; and a support member (elastic support member) extending in a seat front to rear direction to bridge the front connecting frame and the rear connecting frame, and supporting a seated occupant from below (for example, refer to PATENT LITERATURE 1).

A conveyance seat described in PATENT LITERATURE 1 includes right and left side frames; a front frame and a rear frame connecting the right and left side frames; and a support member having a plate shape, extending in a seat front to rear direction to bridge the front frame and the rear frame, and supporting a seated occupant.

The support member includes a resin member having a plate shape and having a support surface that supports the seated occupant, and a bridging member (bridging wire) that holds the resin member and that bridges the front frame and the rear frame. The resin member includes a central support portion (base portion) and side support portions (second support portions) extending from the central support portion outward in a right to left direction while inclining. In addition, the bridging member is attached to a bottom surface of the resin member, or is integrally attached inside the resin member.

### CITATION LIST

### Patent Literature

PATENT LITERATURE 1: JP 2018-161912 A

### SUMMARY OF INVENTION

### Technical Problem

By the way, in the conveyance seat as disclosed in PATENT LITERATURE 1, the bridging member passes through the central support portion and portions of the side support portions of the resin member, and bridges a front connecting frame and a rear connecting frame. For that reason, the bridging member cannot hold outer edge portions of the side support portion, and cannot stably support the seated occupant, which is a risk.

The present invention has been made in view of the above-described problem, and an object of the present invention is to provide a conveyance seat capable of suitably receiving the load of a seated occupant.

### Solution to Problem

The foregoing problem is solved by a conveyance seat of the present invention including a seat frame serving as a skeleton. The seat frame includes a body frame made of a frame-shaped body, and a support member bridging one portion and the other portion of the body frame in a predetermined direction and supporting a seated occupant. The support member includes a central support portion supporting the seated occupant, side support portions provided at positions outside the central support portion in a seat width direction and extending outward in the seat width direction while inclining, and a shape-holding member extending along outer edge portions of the side support portions and bridging the one portion and the other portion of the body frame.

With the above-described configuration, the conveyance seat capable of suitably receiving the load of the seated occupant can be realized.

In detail, the support member includes the central support portion and the side support portions provided at positions outside the central support portion in the seat width direction, and the shape-holding member extends along the outer edge portions of the side support portions. For that reason, the shape-holding member can hold the outer edge portions of the side support portions. Therefore, when the seated occupant is seated, the seated occupant can be stably supported by the support member.

In this configuration, the seat frame may include a cushion frame. The cushion frame may include side frames disposed on right and left sides in the seat width direction as the body frame, a front connecting frame connecting front portions of the right and left side frames, and a rear connecting frame connecting rear portions of the right and left side frames. The shape-holding member may extend in an elongated manner along the outer edge portions of the side support portions, and may bridge the front connecting frame and the rear connecting frame.

With the above-described configuration, the shape-holding member bridges the front connecting frame and the rear connecting frame. For that reason, there is no need to separately provide attachment members for attaching the support member on the front connecting frame and the rear connecting frame, so that an increase in the number of components can be suppressed.

In this configuration, the central support portion may have a mesh shape, and the side support portions may have a mesh shape finer than the mesh shape of the central support portion.

With the above-described configuration, since the side support portions have a fine mesh shape, the strength of the side support portions can be improved, and the seated occupant can be more stably supported.

In this configuration, the shape-holding member may include an attachment portion attached to the body frame. Portions of connection locations between the central support portion and the side support portions may be disposed outside the attachment portion in the seat width direction.

With the above-described configuration, the support force from the sides for the seated occupant can be improved, and the seated occupant can be more stably supported.

In this configuration, the side support portions may extend outward in the seat width direction with respect to the central support portion while inclining to a seated occupant side. The shape-holding member may include an attachment portion attached to the body frame. Extension end portions of the side support portions may be disposed to be closer to the seated occupant side than the attachment portion.

With the above-described configuration, the side support portions extending to incline toward the seated occupant side can improve the support force from the sides for the seated occupant, and can more stably support the seated occupant.

In this configuration, the central support portion may have a mesh shape. A plurality of through-holes penetrating through the central support portion in a direction orthogonal to a support surface of the central support portion may be formed at portions of the support surface that do not have the mesh shape. The plurality of through-holes may be formed to be larger than a mesh of the mesh shape of the central support portion, may be provided at predetermined intervals in the seat width direction at central positions on the central support portion, and may be disposed at positions overlapping the side support portions in a seat front to rear direction.

With the above-described configuration, for example, since the through-holes can be formed at positions corresponding to the ischial bones of the seated occupant, the buttocks of the seated occupant can be stably supported.

In this configuration, the shape-holding member may include an attachment portion attached to the body frame, and the plurality of through-holes may be disposed at positions overlapping the attachment portion in the seat width direction.

With the above-described configuration, when the through-holes are formed at positions corresponding to the ischial bones of the seated occupant, the buttocks of the seated occupant can be more stably supported.

In this configuration, the plurality of through-holes may be disposed behind front end portions of the side support portions in the seat front to rear direction.

With the above-described configuration, when the through-holes are formed at positions corresponding to the ischial bones of the seated occupant, the buttocks of the seated occupant can be more stably supported.

In this configuration, the conveyance seat may further include a detection sensor that detects a biological signal of the seated occupant. The detection sensor may be disposed between the plurality of through-holes in the seat width direction.

With the above-described configuration, when the through-holes are formed at positions corresponding to the ischial bones of the seated occupant, the sensitivity of the detection sensor can be improved.

In this configuration, the seat frame may include the cushion frame. The central support portion may include a first central support portion disposed at a central portion of the cushion frame, and right and left second central support portions provided at positions in front of the first central support portion and protruding from right and left side portions of the first central support portion toward a front side. The shape-holding member may extend along outer edges of the central support portion and the side support portions. The detection sensor may include a sensor attachment portion attached to the shape-holding member. The sensor attachment portion may be disposed at a position in front of the first central support portion in a top view, and may be attached between the right and left second central support portions.

With the above-described configuration, the detection sensor is disposed at a position outside the support member. For that reason, in manufacturing the seat, the degree of freedom in disposing the detection sensor and a harness extending from the detection sensor can be improved, and workability in assembling the components can be improved.

### Advantageous Effects of Invention

According to the present invention, the conveyance seat capable of suitably receiving the load of the seated occupant can be realized.

In addition, according to the present invention, there is no need to separately provide attachment members for attaching the support member on the front connecting frame and the rear connecting frame, so that an increase in the number of components can be suppressed.

In addition, according to the present invention, the seated occupant can be more stably supported.

In addition, according to the present invention, the buttocks of the seated occupant can be more stably supported.

In addition, according to the present invention, the sensitivity of the detection sensor can be improved.

In addition, according to the present invention, in manufacturing the seat, the degree of freedom in disposing the detection sensor and the harness extending from the detection can be improved, and workability in assembling the components can be improved.

### BRIEF DESCRIPTION OF DRAWINGS

FIG. 1 is an external perspective view of a conveyance seat of a first embodiment.

FIG. 2 is a perspective view of pad materials of the conveyance seat.

FIG. 3 is a perspective view of a seat frame.

FIG. 4 is a view showing a manner in which the support member is chucked by a robot arm.

FIG. 5 is a top view of the seat frame, a detection sensor, a vibration device, a blower device, and a control device.

FIG. 6 is a side view of the seat frame, the detection sensor, the vibration device, the blower device, and the control device.

FIG. 7A is a vertical cross-sectional view of the seat frame, and is a view showing a state where the detection sensor is attached to the support member.

FIG. 7B is a view showing a modification example of FIG. 7A.

FIG. 8 is a control block diagram.

FIG. 9 is a top view of the seat frame, and is a view describing the amount of bending when a seating load is applied to the seat frame.

FIG. 10 is a top view of a seat frame of a conveyance seat of a second embodiment.

FIG. 11 is a top view of a seat frame and a blower device of a conveyance seat of a third embodiment.

FIG. 12A is a view showing a state where chuck portions are attached to a shape-holding member.

FIG. 12B is a view showing a state where a chuck portion is partially fitted into the shape-holding member.

FIG. 13 is a top view of a seat frame and a blower device of a conveyance seat of a fourth embodiment.

FIG. 14 is an external perspective view of a conveyance seat of a fifth embodiment.

FIG. 15 is a cross-sectional view of a cushion member taken along line XV-XV in FIG. 14.

FIG. 16 is a view showing Modification Example 1 of FIG. 15.

FIG. 17 is a view showing Modification Example 2 of FIG. 15.

FIG. 18 is a view showing Modification Example 3 of FIG. 15.

FIG. 19 is a view showing Modification Example 4 of FIG. 15.

FIG. 20 is a view showing Modification Example 5 of FIG. 15.

FIG. 21 is a view showing Modification Example 6 of FIG. 15.

FIG. 22 is a view showing Modification Example 7 of FIG. 15.

FIG. 23 is a view showing Modification Example 8 of FIG. 15.

FIG. 24 is a view showing Modification Example 9 of FIG. 15.

FIG. 25 is a view showing Modification Example 10 of FIG. 15.

FIG. 26 is a view showing Modification Example 11 of FIG. 15.

FIG. 27 is a view showing Modification Example 12 of FIG. 15.

FIG. 28 is a control block diagram.

FIG. 29 is a cross-sectional view of a door lining of a sixth embodiment.

FIG. 30 is a view showing a modification example of FIG. 29.

FIG. 31 is a control block diagram.

FIG. 32 is a view showing a seat of a seventh embodiment.

FIG. 33 is a control block diagram.

FIG. 34 is a view showing an arm seat of an eighth embodiment.

FIG. 35 is a control block diagram.

### DESCRIPTION OF EMBODIMENTS

### First Embodiment

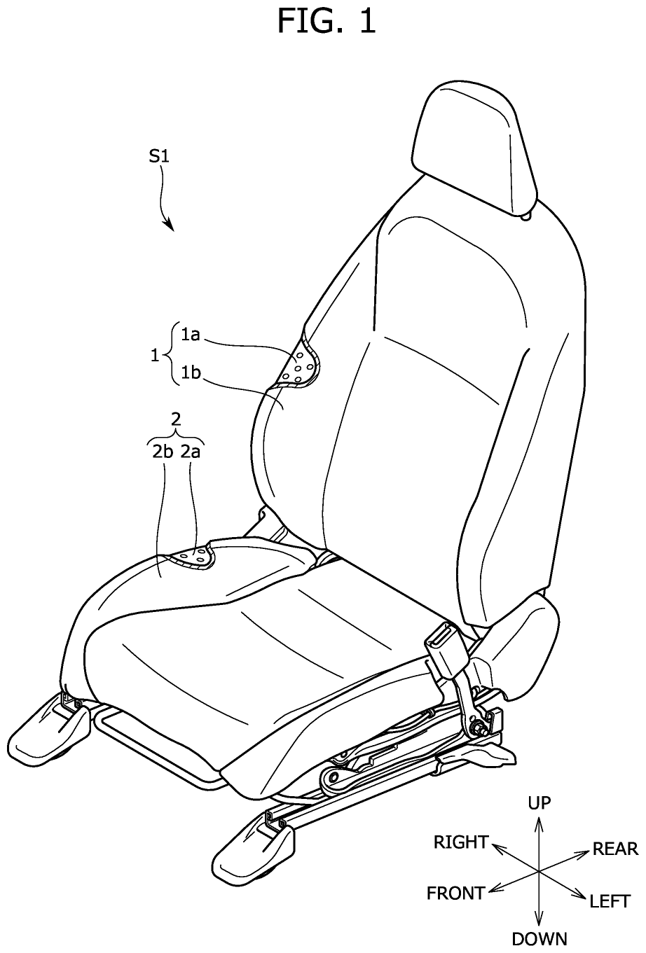

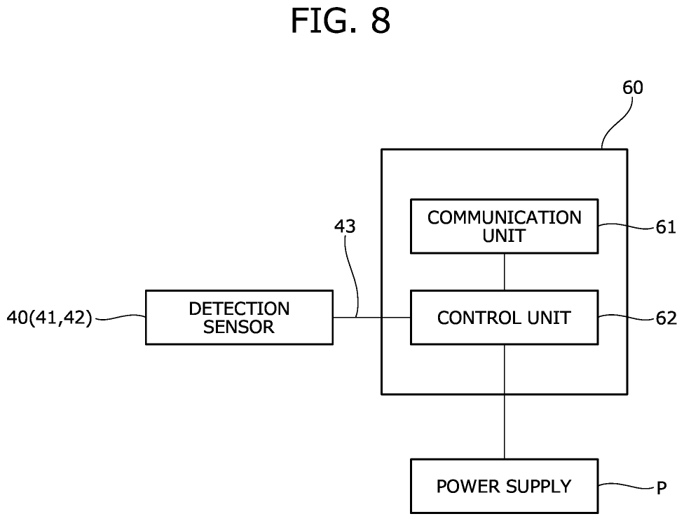

A conveyance seat S1 of a first embodiment will be described with reference to FIGS. 1 to 13.

The first embodiment relates to the invention of a conveyance seat including a seat frame. The seat frame includes a body frame made of a frame-shaped body, and a support member bridging one portion and the other portion of the body frame in a predetermined direction and supporting a seated occupant. The support member includes a central support portion supporting the seated occupant, side support portions provided at positions outside the central support portion in a seat width direction and extending outward in the seat width direction while inclining, and a shape-holding member extending along outer edge portions of the side support portions and bridging the one portion and the other portion of the body frame.

Incidentally, a side on which the seated occupant is seated with respect to a seat back of the conveyance seat is a seat front side.

### <<Overall Configuration of Conveyance Seat>>

As shown in FIGS. 1 to 8, a conveyance seat S1 of a first embodiment is a vehicle seat, and includes a seat body including a seat back 1 and a seat cushion 2; a detection sensor 40 attached inside the seat body to detect a biological signal of a seated occupant seated in the seat body; a vibration device 45 that applies vibration to the seated occupant; a blower device 50 that blows air toward the seated occupant; and a control device 60 that receives the biological signal detected by the detection sensor 40 and that controls the vibration device 45 and the blower device 50 based on the biological signal.

In addition, the conveyance seat S1 further includes a rail device 70 that supports the seat body so as to be movable forward and rearward with respect to a vehicle body floor; a height link device 80 that raisably and lowerably connects the seat body to the vehicle body floor (rail device 70); and a reclining device 90 that rotatably connects the seat back 1 to the seat cushion 2.

Incidentally, the control device 60 can also control the rail device 70, the height link device 80, and the reclining device 90 based on the biological signal. In addition, the biological signal can also be transmitted to the outside.

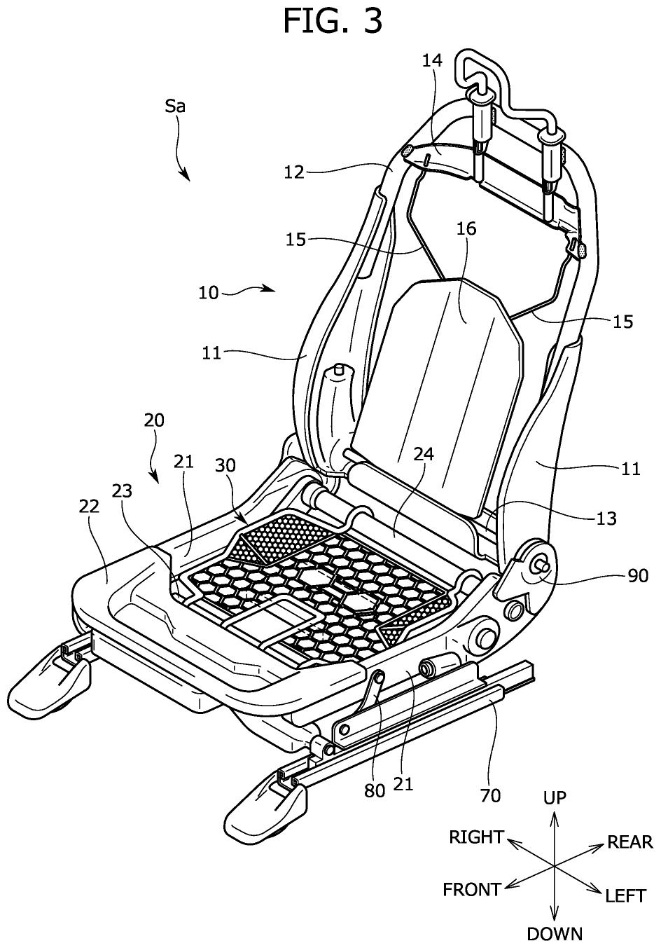

As shown in FIG. 1, the seat back 1 is a backrest portion that supports the seated occupant from behind, and is configured by placing a pad material 1a on the back frame 10 serving as a skeleton shown in FIG. 3 and by covering the pad material 1a and the back frame 10 with a skin material 1b.

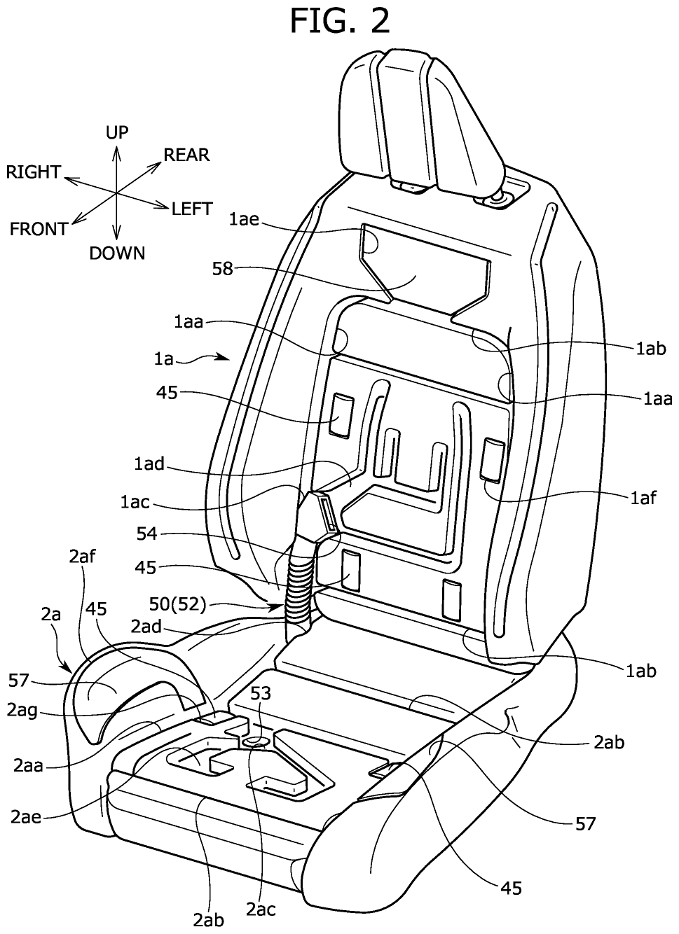

As shown in FIG. 2, the vibration device 45 (upper vibration members 45a and lower vibration members 45b) and the blower device 50 are disposed inside the seat back 1.

As shown in FIG. 2, on a surface of the pad material 1a, first skin pull-in grooves 1aa and second skin pull-in grooves lab for pulling in the skin material 1b, an insertion hole lac that accommodates an outlet 54 of the blower device 50, a ventilation hole lad having a recessed shape and configured to pass the air blown from the outlet 54, and a bag accommodating recess 1ae that accommodates a ventilation bag 58 of the blower device 50 are formed.

In addition, on the surface of the pad material 1a, a plurality of storage recesses 1af disposed in a region surrounded by the first skin pull-in grooves 1aa and the second skin pull-in grooves lab, formed at intervals in a seat width direction and an up to down direction, and configured to store the vibration device 45 are formed.

A plurality of the first skin pull-in grooves 1aa are formed at an interval in the seat width direction, and extend in the up to down direction. A plurality of the second skin pull-in grooves lab are formed at an interval in the up to down direction, and extend in the seat width direction to connect the right and left first skin pull-in grooves 1aa.

The insertion hole lac is disposed at a lower position on a side portion of the pad material 1a, and is formed at a position overlapping the first skin pull-in groove 1aa.

The ventilation hole lad is formed continuously from the insertion hole lac, and extends toward the upper side while branching. The ventilation hole lad allows air to be blown toward the seated occupant over substantially the entirety of a central portion of the seat back 1.

The bag accommodating recess 1ae is disposed at an upper position on the pad material 1a. Incidentally, the outlet (not shown) of the blower device 50 is connected to the bag accommodating recess 1ae.

As shown in FIG. 1, the seat cushion 2 is a seating portion that supports the seated occupant from below, and is configured by placing a pad material 2a on the cushion frame 20 serving as a skeleton shown in FIG. 3 and by covering the pad material 2a and the cushion frame 20 with a skin material 2b.

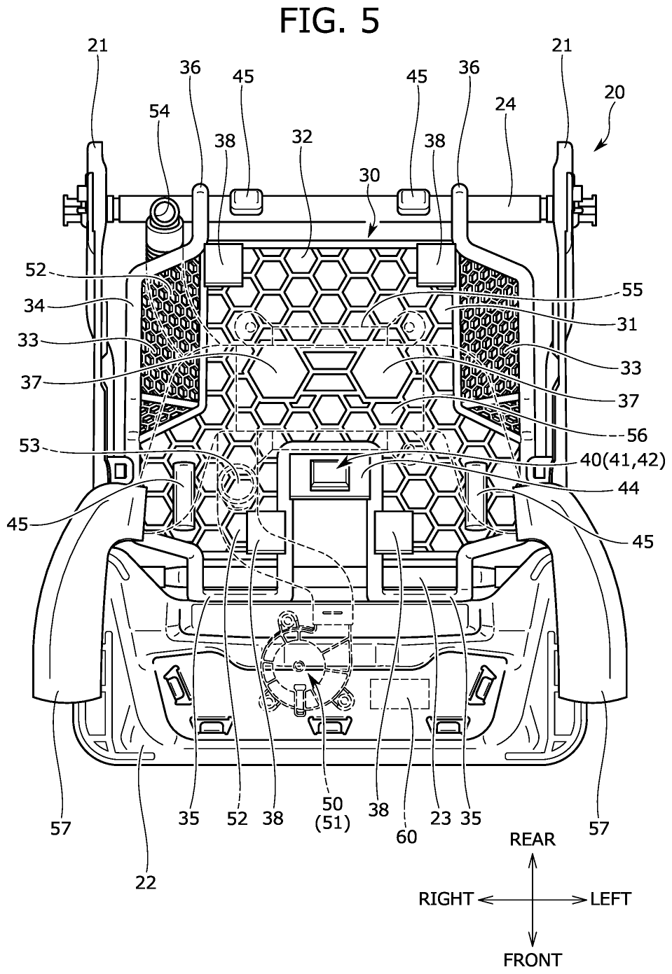

As shown in FIGS. 2 and 5, the detection sensor 40, the vibration device 45 (front vibration members 45c and rear vibration members 45d), the blower device 50, and the control device 60 are disposed inside the seat cushion 2.

As shown in FIG. 2, on a surface of a central portion of the pad material 2a, first skin pull-in grooves 2aa, second skin pull-in grooves 2ab, insertion holes 2ac and 2ad having a circular shape, into which an outlet 53 and a duct 52 of the blower device 50 are inserted, and a ventilation hole 2ae having a recessed shape and configured to pass air blown from the outlet 53 are formed.

In addition, a bag accommodating recess 2af that accommodates a ventilation bag 57 of the blower device 50 is formed on a surface of a side portion of the pad material 2a.

In addition, on the surface of the central portion of the pad material 2a, right and left storage recesses 2ag disposed in a region surrounded by the first skin pull-in grooves 2aa and the second skin pull-in grooves 2ab, formed on the right and left sides in the seat width direction, and configured to store the vibration device 45 are formed.

A plurality of the first skin pull-in grooves 2aa are formed at an interval in the seat width direction, and extend in the up to down direction. A plurality of the second skin pull-in grooves 2ab are formed at an interval in the up to down direction, and extend in the seat width direction to connect the right and left first skin pull-in grooves 2aa.

Each of the insertion holes 2ac and 2ad is a hole penetrating through the pad material 2a in the up to down direction. The insertion hole 2ac is disposed at a central portion of the pad material 2a, and the insertion hole 2ad is disposed at a rear position on the side portion of the pad material 2a. In addition, the insertion hole 2ad is formed at a position overlapping the first skin pull-in groove 2aa.

The ventilation hole 2ae is formed continuously from the insertion hole 2ac, and extends toward the front of the seat while branching. The ventilation hole 2ae allows air to be blown toward the seated occupant over substantially the entirety of a central portion of the seat cushion 2.

The bag accommodating recess 2af is disposed at a front position on the side portion of the pad material 2a. Incidentally, the outlet (not shown) of the blower device 50 is connected to the bag accommodating recess 2af.

As shown in FIG. 3, the back frame 10 is made of a substantially rectangular frame-shaped body, and mainly includes back side frames 11 disposed on the right and left sides; an upper frame 12 having an inverted U shape and connecting upper end portions of the back side frames 11; a lower frame 13 having a plate shape and connecting lower end portions of the back side frames 11; a member frame 14 connecting right and left side portions of the upper frame 12; a plurality of wire members 15 bridging the member frame 14 and the lower frame 13; and a holding member 16 having a plate shape, held by the plurality of wire members 15, and supporting the seated occupant from behind.

Incidentally, a combination of the right and left back side frames 11, the upper frame 12, and the lower frame 13 corresponds to a “body frame”.

The back side frames 11 are sheet metal members extending in the up to down direction and having a substantially C-shaped horizontal cross section, and lower end portions of the back side frames 11 are connected to rear end portions of side frames 21 via the reclining device 90.

In the above-described configuration, the back frame 10 is rotatable relative to the cushion frame 20.

As shown in FIGS. 3 and 5, the cushion frame 20 is made of a substantially rectangular frame-shaped body, and mainly includes the side frames 21 disposed on the right and left sides and extending in a seat front to rear direction; a pan frame 22 having a plate shape and installed on front end portions of the side frames 21 in a bridging manner; a front connecting frame 23 connecting front portions of the side frames 21; a rear connecting frame 24 connecting rear portions of the side frames 21; and a support member 30 having a plate shape, bridging the front connecting frame 23 and the rear connecting frame 24, and supporting the seated occupant from below.

Incidentally, a combination of the right and left side frames 21, the pan frame 22, the front connecting frame 23, and the rear connecting frame 24 corresponds to a “body frame”.

The side frames 21 are plate-shaped frames that are elongated in the seat front to rear direction.

The reclining device 90 is attached to the rear portions of the side frame 21, and the rail device 70 is attached to lower portions of the side frames 21 via the height link device 80.

The pan frame 22 is a frame that supports the thighs of the seated occupant, and is made of a rectangular plate body, and both end portions of the pan frame 22 in the seat width direction are placed and attached to upper surfaces of the side frames 21.

The control device 60 is attached to a back surface of the pan frame 22.

Each of the front connecting frame 23 and the rear connecting frame 24 is a pipe-shaped frame, connects the right and left side frames 21, and connects right and left links of the height link device 80.

### <<Support Member>>

As shown in FIGS. 3 to 5, the support member 30 is a plate-shaped elastic support member that supports the buttocks of the seated occupant, bridges the front connecting frame 23 and the rear connecting frame 24, and can be bent in the up to down direction in response to (following) the motion of the seated occupant.

The support member 30 has a mesh shape, and has a plurality of mesh holes 30a and 30b penetrating therethrough in a direction orthogonal to a support surface of the support member 30. Specifically, the support member 30 is a planar body having a mesh shape and made of an elastic resin material, and is also referred to as an elastomer panel.

Each of the mesh holes 30a and 30b is a hexagonal (substantially hexagonal) hole, and the holes 30a are formed to be larger than the holes 30b.

In detail, the mesh of the support member 30 has a honeycomb shape (honeycomb structure), and is formed to partition hexagonal spaces without gaps.

By adopting a honeycomb shape as described above, the support surface of the support member 30 is allowed to have an excellent load distribution and high strength, and to have high resistance to torsion or twisting and high rigidity. In addition, since the volume of the mesh is minimized in the filling of a three-dimensional space formed by a figure with the same volume, weight reduction can be achieved.

Incidentally, the mesh shape of the support member 30 is not particularly limited to a honeycomb shape, and may be, for example, a grid pattern mesh.

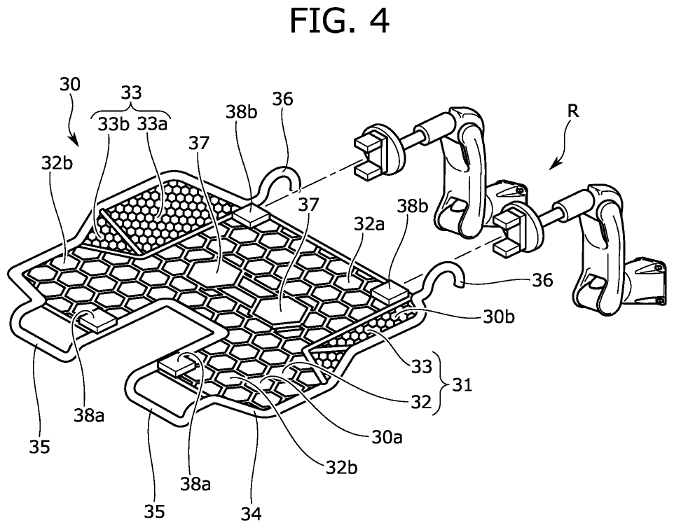

As shown in FIGS. 4 and 5, the support member 30 includes a support body portion 31 having a mesh shape; a shape-holding member 34 that holds the support body portion 31 in a surrounding manner and that extends in the seat front to rear direction to bridge the front connecting frame 23 and the rear connecting frame 24, and a chuck portion 38 having a planar shape and intended for a robot arm R to chuck.

The support member 30 is configured such that the support body portion 31 made of resin and the shape-holding member 34 made of metal are integrally formed. Incidentally, the shape-holding member 34 is attached to an upper surface of the support body portion 31, but is not particularly limited thereto, and may be attached to a bottom surface or a side surface of the support body portion 31. Alternatively, the shape-holding member 34 may be insert-molded inside the support body portion 31.

As shown in FIGS. 4 and 5, the support body portion 31 includes a central support portion 32 that supports the seated occupant, and side support portions 33 provided at positions outside the central support portion 32 in the seat width direction and extending outward in the seat width direction while inclining.

A plurality of through-holes 37 penetrating through the central support portion 32 in a direction orthogonal to a support surface of the central support portion 32 are formed on the support surface.

The central support portion 32 supports the buttocks and thighs of the seated occupant from below, and the side support portions 33 support the buttocks of the seated occupant from the sides. For that reason, the support body portion 31 can support the seated occupant three-dimensionally.

The central support portion 32 includes a first central support portion 32a disposed at a central portion of the cushion frame 20, and right and left second central support portions 32b provided at positions in front of the first central support portion 32a and protruding from right and left side portions of the first central support portion 32a toward the front side.

The first central support portion 32a supports the buttocks of the seated occupant, and the right and left second central support portions 32b support the thighs of the seated occupant.

Each of the side support portions 33 includes a first side support portion 33a provided at a position outside the central support portion 32 in the seat width direction and extending outward in the seat width direction while inclining upward, and a second side support portion 33b extending from the first side support portion 33a toward a seat front side while inclining downward, and connected to the second central support portion 32b. The first side support portions 33a support the buttocks of the seated occupant from the sides.

As shown in FIG. 4, the central support portion 32 has the mesh holes 30a therethroughout, and the side support portions 33 have the mesh holes 30b therethroughout.

The side support portions 33 have a mesh shape finer than the mesh shape of the central support portion 32, and are formed to be harder than the central support portion 32. Namely, the support body portion 31 is formed to be soft at a position where the load received from the seated occupant is at its greatest (position below the buttocks) and to be hard at positions where the load is smaller than at the position below the buttocks (positions beside the buttocks).

In consequence, the strength of the side support portions 33 can be improved, and the seated occupant can be stably supported from the sides.

Incidentally, in the first embodiment, the entirety of the support body portion 31 has a mesh shape; however, a configuration in which a portion of the support body portion 31 has a mesh shape may be adopted.

As shown in FIGS. 4 and 5, the shape-holding member 34 is a wire-shaped shape-holding wire, and holds the support body portion 31 in a surrounding manner. Specifically, the shape-holding member 34 extends along an outer edge portion of each of the central support portion 32 and the side support portions 33.

In detail, the shape-holding member 34 extends forward from a rear end portion of the left side support portion 33 along the outer edge portion of the side support portion 33, and extends along the outer edge portion of the left second central support portion 32b. Then, the shape-holding member 34 passes through the outer edge portion (front end portion) of the first central support portion 32a, and extends along the outer edge portion of the right second central support portion 32b. Then, the shape-holding member 34 extends along the outer edge portion of the right side support portion 33, and extends to a rear end portion of the side support portion 33.

The shape-holding member 34 includes front attachment portions 35 attached to the front connecting frame 23, and rear attachment portions 36 attached to the rear connecting frame 24.

The front attachment portions 35 are provided on the right and left sides at a predetermined interval in an extending direction of the front connecting frame 23, and are hooked onto the front connecting frame 23 from above.

The rear attachment portions 36 are provided on the right and left sides at a predetermined interval in an extending direction of the rear connecting frame 24, and are hooked onto the rear connecting frame 24 from above.

The front attachment portions 35 and the rear attachment portions 36 are formed as portions of the shape-holding member 34. For that reason, there is no need to newly provide attachment portions on the support member 30, so that an increase in the number of components can be suppressed.

As shown in FIGS. 4 and 5, the plurality of through-holes 37 are provided at portions of a support surface of the support body portion 31 (central support portion 32), the portions not having the holes 30a, and penetrate therethrough in a direction orthogonal to the support surface.

The through-holes 37 are provided in right and left two locations at central positions on the central support portion 32, and are provided at positions corresponding to the ischial bones of the seated occupant.

In detail, the through-holes 37 are disposed at positions overlapping the side support portions 33 in the seat front to rear direction, and are disposed at positions overlapping the front attachment portions 35 in a right to left direction. In addition, the through-holes 37 are disposed behind front end portions of the first side support portions 33a in the seat front to rear direction.

As shown in FIG. 4, the through-holes 37 are formed to be larger than the mesh holes 30a of the central support portion 32. Generally, portions of the seat cushion 2 corresponding to the ischial bones of the seated occupant are locations where the seating pressure is at its highest, so that by forming the through-holes 37 at the corresponding portions of the central support portion 32, the support member 30 is made easier to bend.

In consequence, the seating pressure at portions of the support member 30 where the seating pressure is at its highest is reduced, and a good seating feeling can be obtained.

As shown in FIGS. 4 and 5, the chuck portion 38 is a flat plate-shaped member, and is intended for the robot arm R to chuck when the support member 30 is assembled to the cushion frame 20.

The chuck portion 38 includes right and left front chuck portions 38a provided on the front side of the support surface of the support body portion 31, and right and left rear chuck portions 38b provided on the rear side of the support surface of the support body portion 31.

As shown in FIG. 5, the right and left front chuck portions 38a are provided at front end portions of the right and left second central support portions 32b, respectively, and are disposed at respective central positions in the right to left direction.

The front chuck portions 38a are disposed at positions overlapping the front attachment portions 35 in the right to left direction, and are disposed at positions adjacent to the shape-holding member 34.

The right and left rear chuck portions 38b are provided at rear portions of the first central support portion 32a, respectively, and are disposed at respective outer positions in the right to left direction. In addition, the right and left rear chuck portions 38b are disposed at positions close to the right and left side support portions 33.

As shown in FIGS. 4 and 5, the chuck portion 38 is formed to be larger than the plurality of through-holes 37, and is formed to be thinner than a diameter of the shape-holding member 34.

With the above-described configuration, the robot arm R can stably chuck the chuck portion 38, and the chuck portion 38 can be downsized.

Incidentally, the chuck portion 38 may be made of a metal plate including a magnetic material. In consequence, the robot arm R can chuck the support member 30 not only using a mechanical chuck or an air chuck but also using an electromagnetic chuck.

In the above-described configuration, as shown in FIG. 3, the shape-holding member 34 extends in an elongated manner along the outer edge portions of the side support portions 33, and bridges the front connecting frame 23 and the rear connecting frame 24.

In consequence, there is no need to separately provide attachment members for attaching the support member 30 on the front connecting frame 23 and the rear connecting frame 24, so that an increase in the number of components can be suppressed.

In the above-described configuration, as shown in FIG. 4, the central support portion 32 has the mesh holes 30a, and the side support portions 33 have the mesh holes 30b finer than the mesh holes 30a of the central support portion 32.

In consequence, since the side support portions 33 have a fine mesh shape, the strength of the side support portions 33 can be improved, and the seated occupant can be more stably supported.

In the above-described configuration, as shown in FIG. 5, portions of connection locations between the central support portion 32 and the side support portions 33 are disposed outside the front attachment portions 35 in the seat width direction.

In consequence, the support force from the sides for the seated occupant can be improved, and the seated occupant can be more stably supported.

In the above-described configuration, as shown in FIG. 5, extension end portions of the side support portions 33 are disposed to be closer to a seated occupant side than the attachment portions 35 and 36.

In consequence, the support force from the sides for the seated occupant can be improved, and the seated occupant can be more stably supported.

In the above-described configuration, as shown in FIG. 5, the plurality of through-holes 37 are disposed at the positions overlapping the side support portions 33 in the seat front to rear direction.

In consequence, the buttocks of the seated occupant can be stably supported.

In the above-described configuration, as shown in FIG. 5, the plurality of through-holes 37 are disposed at the positions overlapping the front attachment portions 35 in the seat width direction.

In consequence, the buttocks of the seated occupant can be more stably supported.

In the above-described configuration, as shown in FIG. 5, the plurality of through-holes 37 may be disposed behind the front end portions of the side support portions 33 in the seat front to rear direction.

In consequence, when the through-holes are formed at positions corresponding to the ischial bones of the seated occupant, the buttocks of the seated occupant can be more stably supported.

### <<Detection Sensor>>

As shown in FIGS. 5 to 8, the detection sensor 40 is a sheet-shaped pressure sensor that detects a seating pressure applied to a seating surface of the seat cushion 2 when the seated occupant is seated in the seat, and is attached to the support member 30 via a sensor attachment portion 44.

Here, “seating pressure” is a value that changes periodically according to the physiological activity of the seated occupant, specifically, breathing in a state where the seated occupant is seated on the seat cushion 2, and is a target value detected by the pressure sensor. Namely, “seating pressure” corresponds to a “biological signal (biological information) of the seated occupant”

Incidentally, the detection sensor 40 may be a seating sensor that turns on or off depending on the seating pressure of the seated occupant. Preferably, the detection sensor 40 is a push switch type seating sensor. In addition, the detection sensor 40 detects a seating pressure, and outputs a detection signal based on the detection result of the seating pressure.

The detection sensor 40 includes a sensor detection portion 41 that detects a seating pressure caused by the seated occupant, and a transmission line 42 for outputting a detection signal when the sensor detection portion 41 detects the seating pressure.

The sensor detection portion 41 is a pressure sensitive switch adhered onto a conductive sheet.

The transmission line 42 is configured by adhering a conductive wire serving as a transmission line onto the conductive sheet. The transmission line 42 extends from the sensor detection portion 41 to the front of the seat, and is electrically connected to a connection member 43.

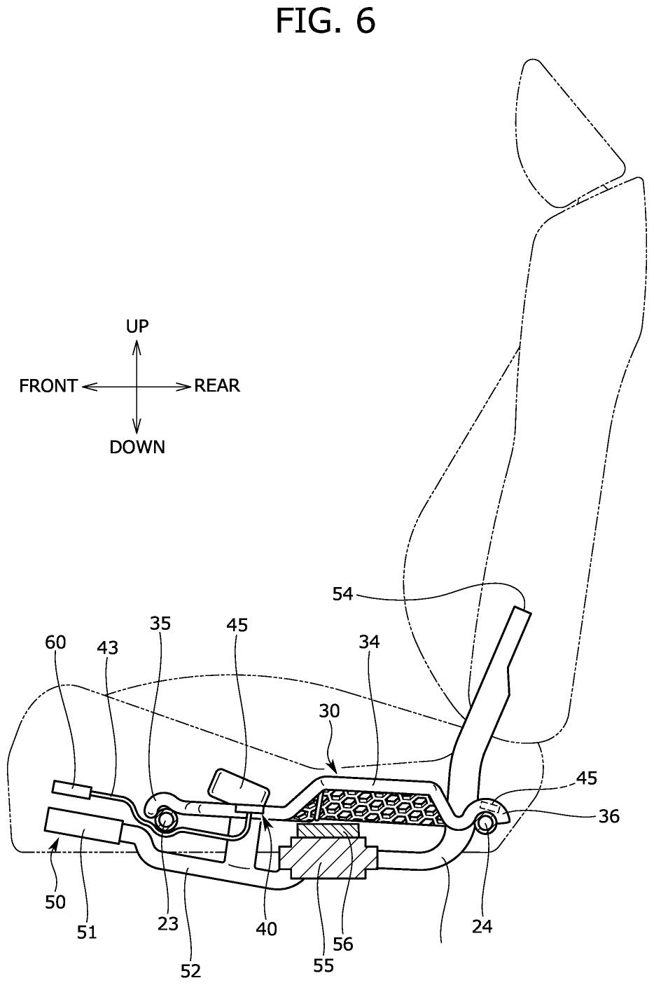

As shown in FIG. 6, the connection member 43 is a wire harness formed by bundling conductive wires, and connects the detection sensor 40 and the control device 60.

The detection sensor 40 is attached to the support member 30 (shape-holding member 34) via the sensor attachment portion 44. The sensor attachment portion 44 is a plate-shaped member, and is formed integrally with the shape-holding member 34.

The sensor attachment portion 44 is disposed at a position in front of the first central support portion 32a of the central support portion 32, and is attached between the right and left second central support portions 32b.

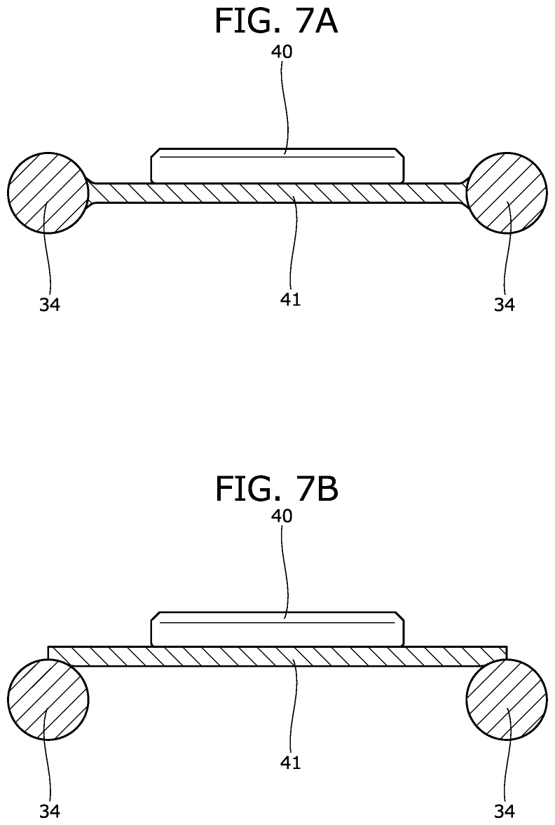

As shown in FIG. 7A, the sensor attachment portion 44 is formed integrally with the shape-holding member 34 at a central portion of the shape-holding member 34 in the up to down direction.

As a modification example, as shown in FIG. 7B, the sensor attachment portion 44 may be integrally attached to an upper surface of the shape-holding member 34.

As shown in FIGS. 4 and 5, the detection sensor 40 is disposed at a position outside the support member 30 in a region surrounded by the cushion frame 20. Specifically, the detection sensor 40 is disposed between the plurality of through-holes 37 in the right to left direction, and is disposed in front of the first central support portion 32a.

In addition, the detection sensor 40 is disposed between the right and left front attachment portions 35, and is disposed behind the front attachment portions 35.

As shown in FIG. 5, the front chuck portions 38a are disposed at the front end portions of the right and left second central support portions 32b, and are disposed at respective end portions on a seat center side.

The rear chuck portions 38b are disposed at rear end portions of the first central support portion 32a, and are disposed at positions close to the respective side support portions 33.

Therefore, the detection sensor 40 is disposed at a position not overlapping the chuck portion 38 in the front to rear direction and the right to left direction.

In the above-described configuration, as shown in FIG. 5, the detection sensor 40 is disposed between the plurality of through-holes 37 in the seat width direction.

In consequence, the sensitivity of the detection sensor 40 can be improved.

### <<Vibration Device>>

As shown in FIGS. 2, 5, and 6, the vibration device 45 corresponds to a drive unit that applies a physical force to the seated occupant, and specifically, is a device including a vibration motor that starts vibration upon receiving a signal from the control device 60.

The vibration device 45 includes the upper vibration members 45a and the lower vibration members 45b provided on the back frame 10, and the front vibration members 45c and the rear vibration members 45d provided on the cushion frame 20.

The vibration members 45a and 45b can apply stimulation to the back of the seated occupant, and the vibration members 45c and 45d can apply stimulation to the buttocks of the seated occupant.

As shown in FIG. 5, the front vibration members 45c are disposed at positions overlapping the second central support portions 32b in a top view. The rear vibration members 45d are disposed on the rear connecting frame 24 at positions close to the rear attachment portions 36.

Incidentally, the detection sensor 40 is disposed between the plurality of through-holes 37 in the right to left direction. For that reason, the detection sensor 40 is disposed at a position not overlapping the front vibration members 45c and the rear vibration members 45d.

As shown in FIG. 6, the front vibration members 45c are disposed at positions overlapping the second central support portions 32b in the front to rear direction. The rear vibration members 45d are disposed at positions overlapping the rear attachment portions 36 in the front to rear direction.

Incidentally, the detection sensor 40 is disposed in front of the first central support portion 32a and behind the front attachment portions 35 in the front to rear direction. For that reason, the detection sensor 40 is disposed at a position overlapping the front vibration members 45c, and is disposed at a position not overlapping the rear vibration members 45d.

In the above-described configuration, as shown in FIG. 5, the shape-holding member 34 extends along outer edges of the central support portion 32 and the side support portions 33. Then, the sensor attachment portion 44 is disposed at a position in front of the first central support portion 32a, and is attached between the right and left second central support portions 32b.

In consequence, in manufacturing the seat, the degree of freedom in disposing the detection sensor 40 and the connection member 43 (harness) extending from the detection sensor 40 can be improved, and workability in assembling the components can be improved.

### <<Blower Device>>

As shown in FIGS. 2, 5, and 6, the blower device 50 is attached to the cushion frame 20. The blower device 50 includes a blower body 51 that blows air; the duct 52 for passing the air; the outlets 53 and 54 that blow the air toward the seated occupant; a heat exchange device 55 that adjusts the temperature of the air; a temperature reduction device 56 that reduces heat, vibration, and noise; and the ventilation bags 57 and 58 that allow the air, which is adjusted in temperature by the heat exchange device 55, to enter and exit from the inside.

The blower body 51 is configured to blow the air toward the seated occupant through the outlets 53 and 54 via the duct 52 from the blower body 51.

The duct 52 is connected to the blower body 51, and allows the air from the blower body 51 to pass therethrough. The duct 52 extends rearward from the blower body 51 along the cushion frame 20, and extends upward along the back frame 10.

The outlets 53 and 54 are air blowing ports that blow the air toward the seated occupant, and penetrate through the ventilation holes lad and 2ae of the pad materials 1a and 2a.

The heat exchange device 55 is a device that cools or heats the air circulating through the duct 52 to adjust the temperature of the support surface for the seated occupant, and is provided below the support member 30.

The temperature reduction device 56 is a device that reduces high heat, vibration, and noise caused by the heat exchange device 55, and is attached to the upper side of the heat exchange device 55.

The ventilation bags 57 and 58 heat or cool the body of the seated occupant by being inflated when filled with the air, and are connected to the heat exchange device 55.

The ventilation bag 57 is accommodated in the bag accommodating recess 2af provided in the side portion of the pad material 2a, and heats or cools the buttocks or thighs of the seated occupant.

The ventilation bag 58 is accommodated in the bag accommodating recess 1ae provided on a surface of a central portion of the pad material 1a, and heats or cools the back of the seated occupant.

As shown in FIG. 5, the blower body 51 is disposed in front of the first central support portion 32a. The outlet 53 of the duct 52 is disposed at a position overlapping the left second central support portion 32b in a top view. The heat exchange device 55 and the temperature reduction device 56 are disposed at positions overlapping the through-holes 37 in a top view. The ventilation bag 57 is disposed outside the first central support portion 32a.

Incidentally, the detection sensor 40 is disposed between the plurality of through-holes 37 in the right to left direction. For that reason, the detection sensor 40 is disposed at a position overlapping the blower body 51, the heat exchange device 55, and the temperature reduction device 56 in the right to left direction, and is disposed at a position not overlapping the outlet 53 of the duct 52 and the ventilation bag 57.

As shown in FIG. 6, the blower body 51 is disposed in front of the front attachment portions 35. The outlet 53 of the duct 52 is disposed at a position overlapping the second central support portion 32b in the front to rear direction. The heat exchange device 55 and the temperature reduction device 56 are disposed at positions overlapping the side support portions 33 in the front to rear direction. The ventilation bag 57 is disposed at a position overlapping the second central support portion 32b in the front to rear direction.

Incidentally, the detection sensor 40 is disposed in front of the first central support portion 32a and behind the front attachment portions 35 in the front to rear direction. For that reason, the detection sensor 40 is disposed at a position overlapping the outlet 53 of the duct 52 and the ventilation bag 57 in the front to rear direction, and is disposed at a position not overlapping the blower body 51, the heat exchange device 55, and the temperature reduction device 56.

### <<Control Device>>

As shown in FIGS. 5, 6, and 8, the control device 60 is a device that processes the biological signal detected by the detection sensor 40, and is attached to a bottom surface of the pan frame 22 via a holder (not shown). The control device 60 is electrically connected to the detection sensor 40 by the connection member 43 extending from the detection sensor 40. Incidentally, the connection between the control device 60 and the detection sensor 40 is not limited to wired communication through the connection member 43, and may be wireless communication.

The control device 60 includes a communication unit 61 that receives the biological signal detected by the detection sensor 40 and that wirelessly transmits the biological signal to the outside, and a control unit 62 that performs processing based on the biological signal detected by the detection sensor 40.

The communication unit 61 is connected to an external terminal, for example, a tablet terminal, a smartphone, a computer such as PC, an electrical device using a wireless communication technology, and transmits and receives electrical signals (data signals).

The control unit 62 corresponds to a microcomputer, and comprehensively executes electrical control.

The control device 60 receives a supply of electric power from a power supply P installed in a conveyance.

Incidentally, the control device 60 may be attached inside the conveyance seat S, or may be attached outside the conveyance seat S.

In the above-described configuration, the control device 60 is connected to the vibration device 45 through a network, and notifies the seated occupant to fasten a seat belt by controlling the vibration device 45 to vibrate based on the biological signal detected by the detection sensor 40.

In addition, the control device 60 is connected through a network to a safety device such as a seat belt device (not shown) and a movable device capable of moving a portion or the entirety of the seat body, so that the control device 60 can transmit activation signals toward these devices.

In the above-described configuration, for example, the control device 60 is connected to a known heart rate measuring device (not shown) through a network, so that the heart rate measuring device can measure a heart rate of the seated occupant based on a heart rate signal (heart rate information) or a breathing signal (breathing information) and quickly notify the seated occupant when an abnormality occurs in the heart rate change.

In addition, the “type of the detection sensor” can be changed according to a request of the seated occupant, and an “output function” based on the detected biological information from the detection sensor can be changed.

Specifically, in addition to a pressure sensor, capacitive sensor, a temperature sensor, a sound sensor, an optical sensor, an odor sensor, or the like may be adopted.

In addition, as the “output function”, in addition to measuring a change in the heart rate of the seated occupant and notifying the seated occupant of an abnormality in the heart rate (drowsy state), measuring the seating posture of the seated occupant and controlling the seat movement of the seat to present a relaxation mode or a skeleton correction mode, presenting a game or a video to the seated occupant based on biological information (for example, electrocardiogram, blood pressure, body temperature, breathing, or the like) of the seated occupant, and the like are assumed.

In that case, the biological information obtained by the detection sensor may be used by a dedicated application downloaded to a mobile terminal of the seated occupant.

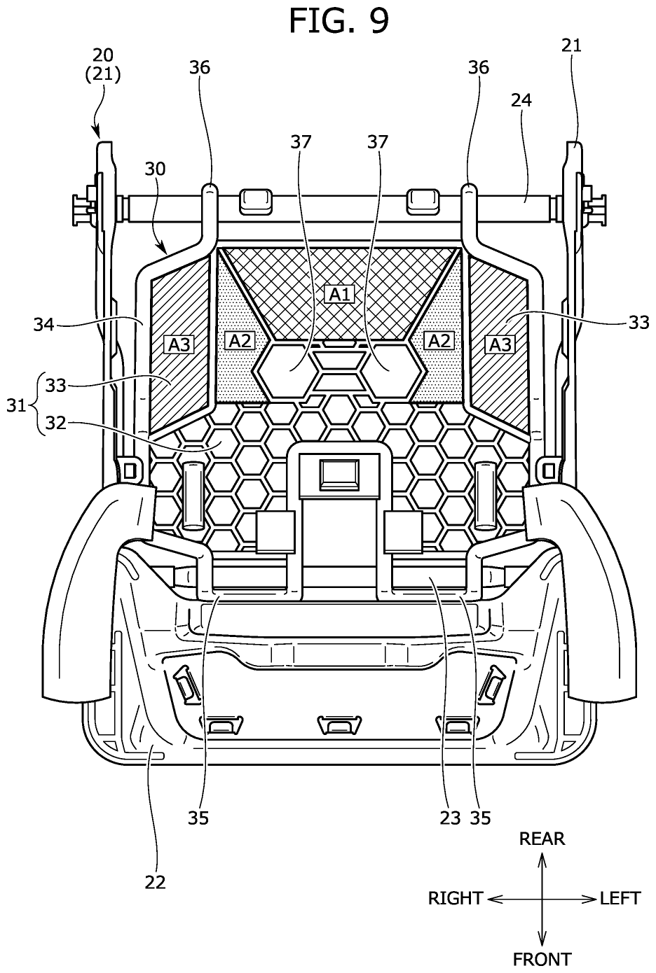

Incidentally, in FIG. 9, the magnitude relationship between the amounts of bending of support regions A1 to A3 when a seating load is applied to the cushion frame 20 is a relationship of A1>A2>A3. Since the support member 30 is formed such that the support regions A1 to A3 have different amounts of bending, the support member 30 can stably support the seated occupant.

Therefore, the conveyance seat capable of suitably receiving the load of the seated occupant can be realized.

### Second Embodiment

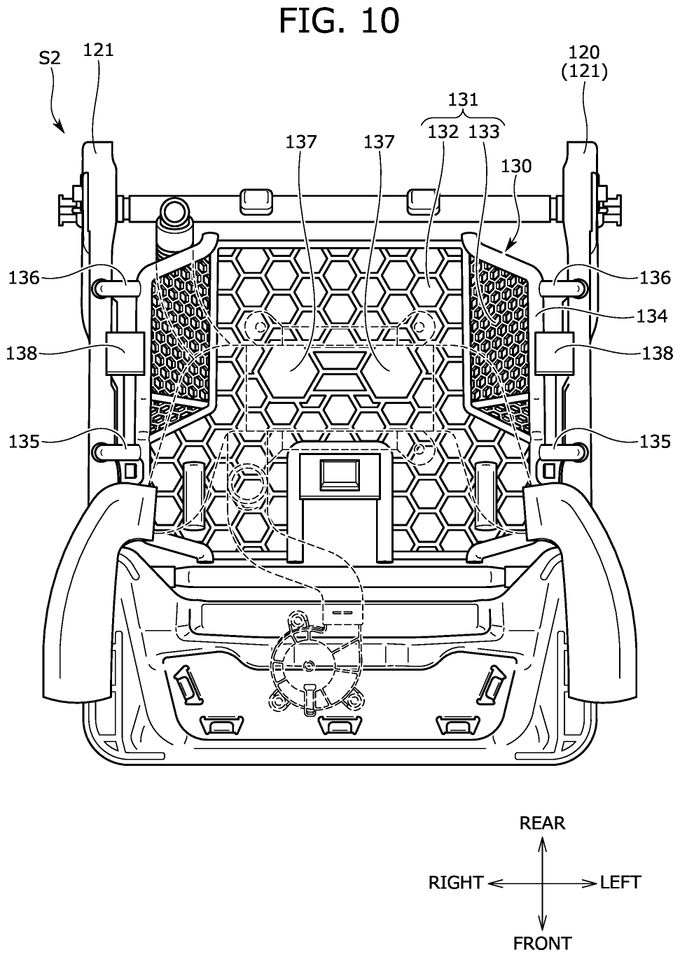

Next, a conveyance seat S2 of a second embodiment will be described based on FIG. 10.

Incidentally, the description of contents that overlap with those of the conveyance seat S1 described above will be omitted.

The conveyance seat S2 of the second embodiment differs from the conveyance seat S1 mainly in the configurations of attachment portions 135 and 136 of a support member 130 and chuck portions 138.

As shown in FIG. 10, the support member 130 includes a support body portion 131 having a mesh shape; a shape-holding member 134 that holds the support body portion 131 in a surrounding manner and that extends in the seat right to left direction to bridge right and left side frames 121; and the chuck portions 138 having a planar shape and intended for the robot arm R to chuck.

The shape-holding member 134 includes front attachment portions 135 attached to a front connecting frame 123, and rear attachment portions 136 attached to a rear connecting frame 124.

The front attachment portions 135 are provided on the right and left sides of the support body portion 131, are inserted into insertion holes from above that are formed at front positions on upper end flanges of the side frames 121, and are hooked onto the side frames 121.

The rear attachment portions 136 are provided on the right and left sides of the support body portion 131, are inserted into insertion holes from above that are formed at rear positions on the upper end flanges of the side frames 121, and are hooked onto the side frames 121.

Even in the above-described embodiment, there is no need to separately provide attachment members for attaching the support member 130 on the side frames 121, so that an increase in the number of components can be suppressed.

In addition, since the support member 130 can be attached to a cushion frame 120 not only in the front to rear direction but also in the right to left direction, the support member 130 can be attached to various types of the cushion frames 120.

As shown in FIG. 10, the chuck portions 138 are provided on the shape-holding member 134 located outside right and left side support portions 133, and are disposed at respective positions overlapping a plurality of through-holes 137 in the front to rear direction.

Even in the above-described embodiment, the robot arm R can stably chuck the chuck portions 138.

### Third Embodiment

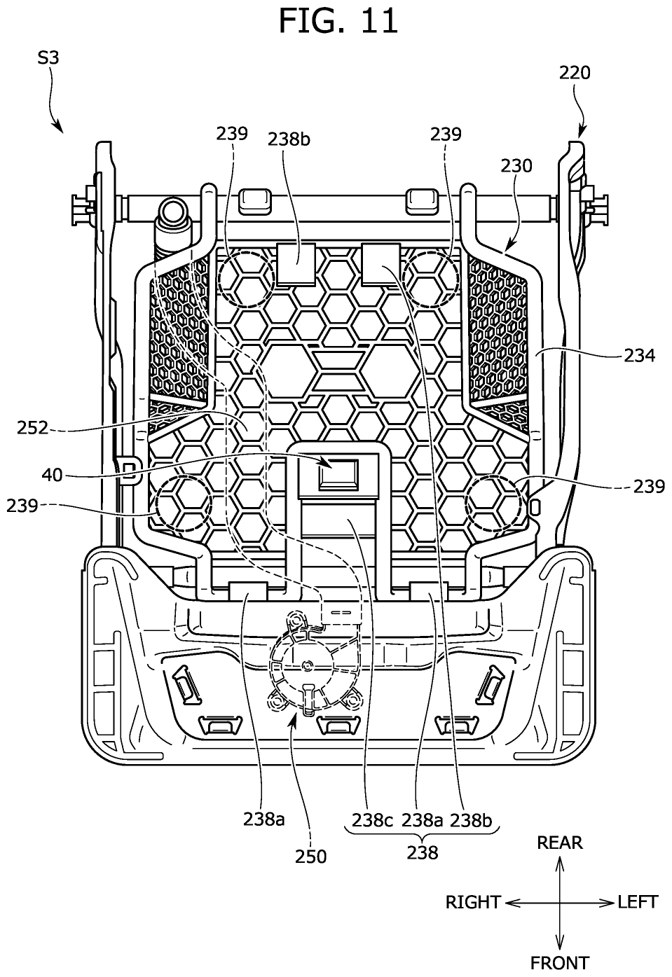

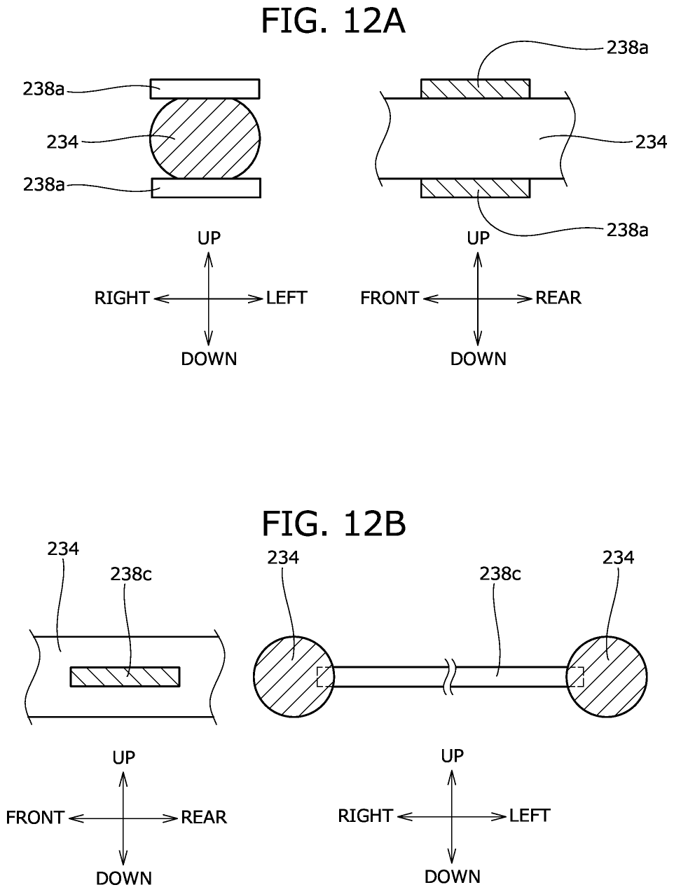

Next, a conveyance seat S3 of a third embodiment will be described based on FIGS. 11, 12A, and 12B.

Incidentally, the description of contents that overlap with those of the conveyance seats S1 and S2 described above will be omitted.

The conveyance seat S3 of the third embodiment differs from the conveyance seats S1 and S2 mainly in the configurations of a chuck portion 238 and compression springs 239 of a support member 230.

As shown in FIG. 11, the chuck portion 238 includes right and left front chuck portions 238a provided on a shape-holding member 234; right and left rear chuck portions 238b provided at rear positions on a support surface of the support member 230; and a central chuck portion 238c provided at a front position on the support surface of the support member 230.

As shown in FIG. 11, the front chuck portions 238a are provided on respective right and left front attachment portions 235.

The rear chuck portions 238b are provided at respective rear end portions of a first central support portion 232a, and are disposed at positions separated from respective right and left side support portions 233 by a predetermined distance.

The central chuck portion 238c is disposed in front of the first central support portion 232a and a detection sensor 240, and is attached between right and left second central support portions 232b.

The front chuck portions 238a and the central chuck portion 238c are disposed at positions not overlapping the support surface of the support member 230 in the up to down direction.

As shown in FIG. 12A, the front chuck portions 238a have a flat plate shape thinner than a diameter of the shape-holding member 234. The front chuck portions 238a are disposed to extend along an extending direction of the shape-holding member 234, and are attached to both surfaces of the shape-holding member 234 in the up to down direction.

As shown in FIG. 12B, the central chuck portion 238c has a flat plate shape thinner than the diameter of the shape-holding member 234. The central chuck portion 238c is attached to the shape-holding member 234 in a partially fitted state.

Even in the above-described embodiment, the robot arm R can stably chuck the chuck portion 238, and the chuck portion 238 can be downsized.

As shown in FIG. 11, the compression springs 239 elastically suppress the horizontal movement of the support surface of the support member 230, and are provided at the positions of four front, rear, right, and left corners of a cushion frame 220.

The compression springs 239 are disposed at positions not overlapping the support member 230 (the shape-holding member 234 and the chuck portion 238), the detection sensor 240, and a blower device 250 in the up to down direction.

The support member 230 is assembled to the cushion frame 220 in a state where the support member 230 is elastically supported from the lower side via the four compression springs 239.

Since a plurality of the compression springs 239 are provided as described above, even when an inertia force in a lateral direction acts on the seated occupant while the vehicle travels, the lateral movement of the head of the seated occupant can be appropriately suppressed, and the line of sight of the seated occupant can be stabilized.

In the above-described configuration, the compression springs 239 are disposed at positions avoiding the shape-holding member 234, and are in contact with a flat support surface of a support body portion 231. In consequence, the support member 230 can be stably supported.

In addition, the compression springs 239 are disposed at positions away from the detection sensor 240. In consequence, a malfunction of the detection sensor 240 can be suppressed.

In the above-described configuration, the compression springs 239 are disposed at positions avoiding a duct 252. In consequence, the interference of the compression springs 239 with the duct 252 can be suppressed.

In addition, the compression springs 239 are disposed at positions away from the chuck portion 238. In consequence, when the robot arm R chucks the support member 230, the interference of the compression springs 239 with the chuck portion 238 can be suppressed.

### Fourth Embodiment

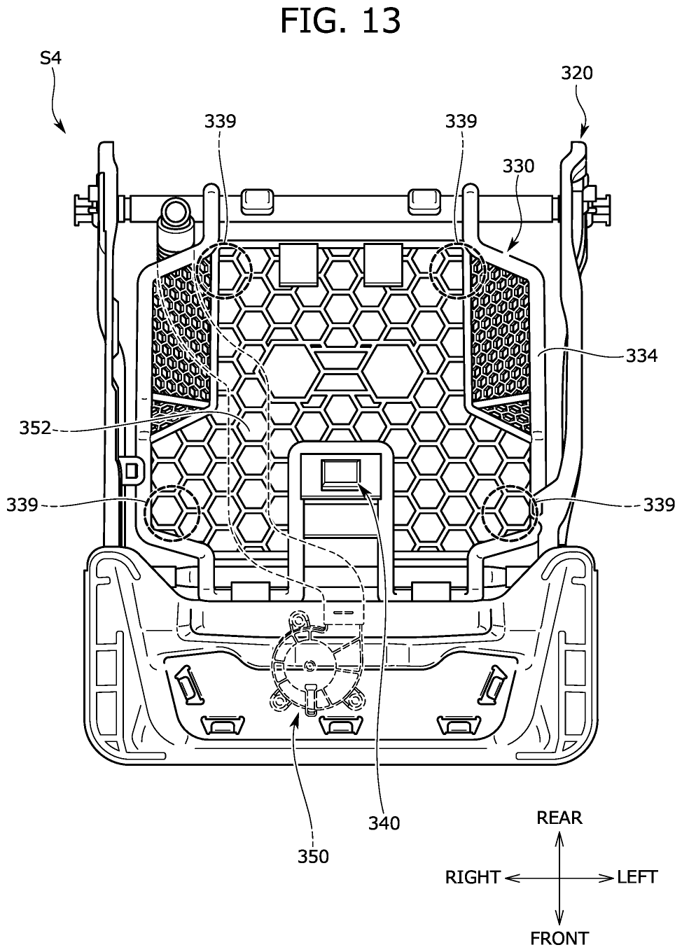

Next, a conveyance seat S4 of a fourth embodiment will be described based on FIG. 13.

Incidentally, the description of contents that overlap with those of the conveyance seats S1 to S3 described above will be omitted.

The conveyance seat S4 of the fourth embodiment differs from the conveyance seats S1 to S3 mainly in the configurations of compression springs 339.

As shown in FIG. 13, the compression springs 339 are disposed at positions overlapping a support member 330 (shape-holding member 334) in an up to down direction, and are disposed at positions not overlapping a detection sensor 340 and a blower device 350 (duct 352).

The support member 330 is assembled to a cushion frame 320 in a state where the support member 330 is elastically supported from the lower side via four compression springs 339.

With the above-described configuration, since the cushion frame 320 includes a plurality of the compression springs 339, even when an inertia force in the lateral direction acts on the seated occupant while the vehicle travels, the lateral movement of the head of the seated occupant can be appropriately suppressed, and the line of sight of the seated occupant can be stabilized.

In the above-described configuration, the compression springs 339 are disposed at positions overlapping the shape-holding member 334 in the up to down direction, and are in contact with the shape-holding member 334 having higher rigidity than a support body portion 331. In consequence, the support member 330 can be stably supported.

In addition, the compression springs 339 are disposed at positions away from the detection sensor 340. In consequence, a malfunction of the detection sensor 340 can be suppressed.

In addition, the compression springs 339 are disposed at positions avoiding the duct 352. In consequence, the interference of the compression springs 339 with the duct 352 can be suppressed.

### OTHERS

In the first to fourth embodiments, as shown in FIG. 3, the conveyance seats S1 and S4 include the rail device 70, the height link device 80, and the reclining device 90, but are not particularly limited thereto.

Namely, the conveyance seats S1 to S4 may not include the rail device 70, the height link device 80, and the reclining device 90.

In the above-described embodiment, as shown in FIG. 3, the support member 30 according to the present invention is configured to be attached to the cushion frame 20, but is not particularly limited thereto, and the support member 30 according to the present invention may be attached to the back frame 10.

In the above-described embodiment, as shown in FIG. 3, the support member 30 extends in the seat front to rear direction to bridge across the cushion frame 20, but is not particularly limited thereto, and may extend in the seat width direction to bridge thereacross.

In addition, the shape-holding member 34 extends along the outer edge portions of the side support portions 33, but may extend along at least a portion of the outer edge portions.

In the above-described embodiment, as shown in FIG. 3, the side support portions 33 extend while inclining to the seated occupant side, but are not particularly limited thereto, and may be inclined to a side opposite to the seated occupant side. Alternatively, the side support portions 33 may not be inclined when the seated occupant is not seated, but may be inclined due to the support surface of the support member 30 being bent when the seated occupant is seated.

In the above-described embodiment, as shown in FIG. 5, a hardness of a peripheral edge portion of a portion of the shape-holding member 34, the detection sensor 40 being attached to the portion, is lower than those of right and left end portions and a front end portion of the shape-holding member 34. However, the present invention is not particularly limited thereto, and the entirety of the shape-holding member 34 may be formed with the same hardness.

In the above-described embodiment, as shown in FIG. 6, the outlet 53 of the duct 52 is disposed not to protrude upward from the support surface of the support member 30, but is not particularly limited thereto.

For example, the outlet 53 may protrude from the through-hole of the support member 30.

### <<Supplementary Note 1>>

According to the conveyance seats S1 to S4, a conveyance seat may include a seat frame serving as a skeleton. The seat frame may include a body frame made of a frame-shaped body, and a support member bridging one portion and the other portion of the body frame in a predetermined direction and having a support surface that supports a seated occupant. The conveyance seat may include a detection sensor attached to the seat frame to detect a biological signal of the seated occupant. The detection sensor may be disposed at a position outside the support member in a region surrounded by the body frame.

With the above-described configuration, in manufacturing the seat, the conveyance seat capable of improving the degree of freedom in wiring and improving workability in assembling the components can be realized.

In detail, since the detection sensor is disposed at a position outside the support member, in manufacturing the seat, the degree of freedom in disposing the detection sensor (a transmission line of the detection sensor) and a harness can be improved, and workability in assembling the components can be improved.

In this configuration, the seat frame may include a cushion frame. The cushion frame may include side frames disposed on right and left sides in the seat width direction as the body frame, a front connecting frame connecting front portions of the right and left side frames, and a rear connecting frame connecting rear portions of the right and left side frames. The support member may include an attachment portion bridging the front connecting frame and the rear connecting frame, and attached to the front connecting frame. A plurality of the attachment portions may be provided at predetermined intervals in the seat width direction. The detection sensor may be disposed between the plurality of attachment portions in the seat width direction.

As described above, since the detection sensor is provided between the plurality of attachment portions, the attachment stability of the detection sensor can be enhanced.

In this configuration, the support member may have a mesh shape. A plurality of through-holes penetrating through the support member in a direction orthogonal to a support surface of the support member may be formed at portions of the support surface that do not have the mesh shape. The plurality of through-holes may be formed to be larger than a mesh of the mesh shape of the support member, and may be provided at predetermined intervals in the seat width direction at central positions on the support member. The detection sensor may be disposed between the plurality of through-holes in the seat width direction.

With the above-described configuration, when the through-holes are disposed at positions corresponding to the ischial bones of the seated occupant, the through-holes and the detection sensor are located to overlap each other in the seat width direction, so that the sensitivity of the detection sensor can be improved.

In this configuration, the conveyance seat may include a blower device attached to the seat frame. The blower device may include a blower body that blows air toward the seated occupant, and a duct connected to the blower body to pass the air. An air blowing port of the duct may be disposed at a position overlapping the support member in a top view, and may be disposed at a position not overlapping the detection sensor.

With the above-described configuration, interference between the detection sensor and the air blowing port of the duct can be suppressed.

In this configuration, the detection sensor may be disposed at a position overlapping the blower body in the seat width direction.

With the above-described configuration, the detection sensor and the blower can be compactly disposed in the seat frame.

In this configuration, the blower body may be disposed in front of the detection sensor.

With the above-described configuration, the detection sensor and the blower body can be disposed away from each other, and a malfunction of the detection sensor can be suppressed.

In this configuration, the conveyance seat may include a vibration device that applies vibration to the seated occupant. The vibration device may be disposed at a position overlapping the support member when viewed in a support direction of the support member, and may be disposed at a position not overlapping the detection sensor.

With the above-described configuration, interference between the detection sensor and the vibration device can be suppressed.

In this configuration, the conveyance seat may include a blower device attached to the seat frame, and a vibration device that applies vibration to the seated occupant. The blower device may include a blower body that blows air toward the seated occupant, and a duct connected to the blower body to pass the air. The detection sensor may be disposed at a position overlapping an air blowing port of the duct and the vibration device in a side view.

With the above-described configuration, the detection sensor, the blower device, and the vibration device can be compactly disposed in the seat frame.

In this configuration, the conveyance seat may include a blower device attached to the seat frame. The blower device may include a heat exchange device attached to the seat frame to adjust a temperature of air. The detection sensor may be disposed at a position different from a position of the heat exchange device when viewed in a support direction of the support member.

With the above-described configuration, the detection sensor and the heat exchange device can be disposed away from each other, and the application of excessive heat to the detection sensor can be suppressed.

In this configuration, the blower device may include a ventilation bag connected to the heat exchange device to allow the air, which is adjusted in temperature by the heat exchange device, to enter and exit from an inside. The detection sensor may be disposed at a position overlapping at least a portion of the ventilation bag in a side view. With the above-described configuration, the detection sensor and the ventilation bag can be compactly disposed in the seat frame.

### <<Supplementary Note 2>>

Further, according to the conveyance seats S1 to S4, a conveyance seat may include a seat frame serving as a skeleton. The seat frame may include a body frame made of a frame-shaped body, and a support member bridging one portion and the other portion of the body frame in a predetermined direction and supporting a seated occupant. The support member may include a support body portion having a mesh shape and supporting the seated occupant, and a shape-holding member that holds the support body portion in a surrounding manner and that extends in the predetermined direction to bridge the one portion and the other portion of the body frame. The support member may be provided with a chuck portion having a planar shape and intended for a robot arm to chuck when the support member is assembled to the body frame.

With the above-described configuration, the conveyance seat in which the assembly work of the components can be made efficient in manufacturing the seat can be realized.

In detail, the support member having a mesh shape is provided with the chuck portion having a planar shape and intended for the robot arm to chuck. In consequence, it is possible to implement the automation of the assembly work of the components in manufacturing the seat.

Incidentally, when the support member (particularly, a support member having a mesh shape) is chucked as it is, the support member is deformed, which is a risk. For that reason, when the chuck portion intended for the robot arm to chuck is not provided, it becomes difficult to automate the assembly work.

In this configuration, the seat frame may include a cushion frame. The cushion frame may include side frames disposed on right and left sides in a seat width direction as the body frame, a front connecting frame connecting front portions of the right and left side frames, and a rear connecting frame connecting rear portions of the right and left side frames. The support member may bridge the front connecting frame and the rear connecting frame. The chuck portion may have a flat plate shape, and may be provided on a support surface of the support body portion.

With the above-described configuration, in the assembly work of the cushion frame, it becomes easy to implement the automation of the assembly work using the robot arm.

In this configuration, the shape-holding member may be a wire-shaped shape-holding wire, and a thickness of the chuck portion may be thinner than a thickness of the shape-holding member.

With the above-described configuration, the chuck portion intended for the robot arm to chuck can be downsized.

In this configuration, the chuck portion may be disposed at a position adjacent to the shape-holding member on the support body portion.

Since the chuck portion is disposed at a position adjacent to the shape-holding member as described above, the support member can be stably chucked by the robot arm.

In this configuration, the shape-holding member may include an attachment portion attached to the body frame. The chuck portion may be provided on the support body portion, and may be disposed at a position overlapping the attachment portion in a seat width direction.

With the above-described configuration, when the support member (attachment portion) is attached to the body frame by the robot arm, a load can be efficiently applied to the attachment portion, and the attachment work can be efficiently performed.

In this configuration, the support body portion may have a mesh shape. The support body portion may have a plurality of mesh holes penetrating through the support body portion in a direction orthogonal to a support surface of the support body portion. The chuck portion may be larger than the plurality of mesh holes when viewed in a support direction of the support member.

Since the chuck portion is formed to be relatively large as described above, the chuck portion can be more stably chucked by the robot arm.

In this configuration, the conveyance seat may include a detection sensor attached to the support member to detect a biological signal of the seated occupant. The detection sensor may be disposed at a position not overlapping the chuck portion in an extending direction of the support member.

In addition, the detection sensor may be disposed at a position not overlapping the chuck portion in a seat width direction.

With the above-described configuration, unintentional interference between the robot arm and the detection sensor can be suppressed.

In this configuration, the chuck portion may be attached onto the shape-holding member, and extend along an extending direction of the shape-holding member.

With the above-described configuration, when the support member (shape-holding member) is bridged to the body frame by the robot arm, a load can be efficiently applied to the bridging portion, and the bridging work (assembling work) can be efficiently performed.

In this configuration, the chuck portion may be attached to the support member, and may be disposed at a position not overlapping a support surface of the support member when viewed in a support direction of the support member.

Since the chuck portion is disposed at a position not overlapping the support surface as described above, discomfort that the seated occupant feels when seated can be reduced.

### Fifth Embodiment

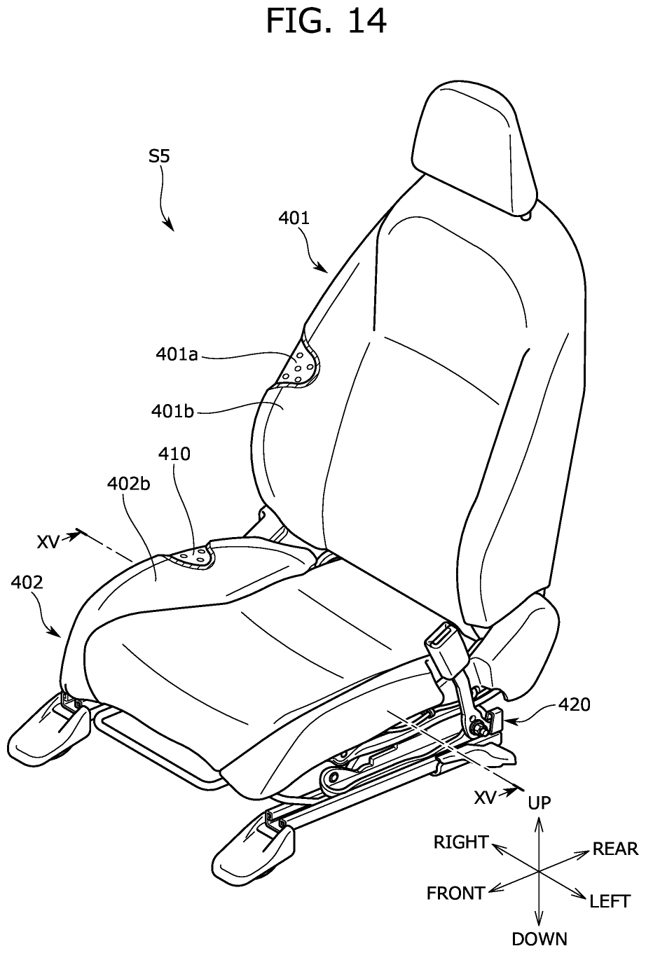

Next, a conveyance seat S5 of a fifth embodiment will be described based on FIGS. 14 to 28.

Incidentally, the description of contents that overlap with those of the conveyance seats S1 to S4 described above will be omitted.

The conveyance seat S5 differs from the conveyance seats S1 to S4 mainly in the configuration of a cushion member 410.

The conveyance seat S5 is a seat including cushion members that are different in hardness, and can suppress deformation (settling) of the cushion member with a low hardness.

### <<Overall Configuration of Conveyance Seat>>

As shown in FIGS. 14 to 28, the conveyance seat S5 of the fifth embodiment is a vehicle seat, and includes a seat body including a seat back 401 and a seat cushion 402; airbag modules 430 attached inside the seat body to store respective airbags; detection sensors 440 that detect biological signals of a seated occupant seated in the seat body; a blower device 450 that blows air toward the seated occupant; a control device 460 that receives the biological signals detected by the detection sensors 440 and that controls the blower device 450; temperature adjustment units 470 that adjust the temperature of the seat body; and notification units 480 that make a notification about the state of the seated occupant.

Incidentally, the control device 460 can also transmit the biological signal to the outside.

As shown in FIG. 14, the seat back 401 is a backrest portion that supports the seated occupant from behind, and is configured by placing a pad material 401a on a back frame (not shown) serving as a skeleton and by covering the pad material 401a and the back frame with a skin material 401b. The airbag modules 430, the detection sensor 440, the blower device 450, the temperature adjustment unit 470, and the notification unit 480 are disposed inside the seat back 401.

A ventilation passage (not shown) having a recessed shape and configured to pass the air blown from an outlet of the blower device 450 is formed on a surface of the pad material 401a. The ventilation passage allows the air to be blown toward the seated occupant over substantially the entirety of a central portion of the seat back 401.

As shown in FIG. 14, the seat cushion 402 is a seating portion that supports the seated occupant from below, and is configured by placing the cushion member 410 on a cushion frame 420 serving as a skeleton and by covering the cushion member 410 and the cushion frame 420 with a skin material 2b.

The airbag modules 430, the detection sensor 440, the blower device 450, the control device 460, the temperature adjustment unit 470, and the notification unit 480 are disposed inside the seat cushion 402.

### <<Cushion Member>>

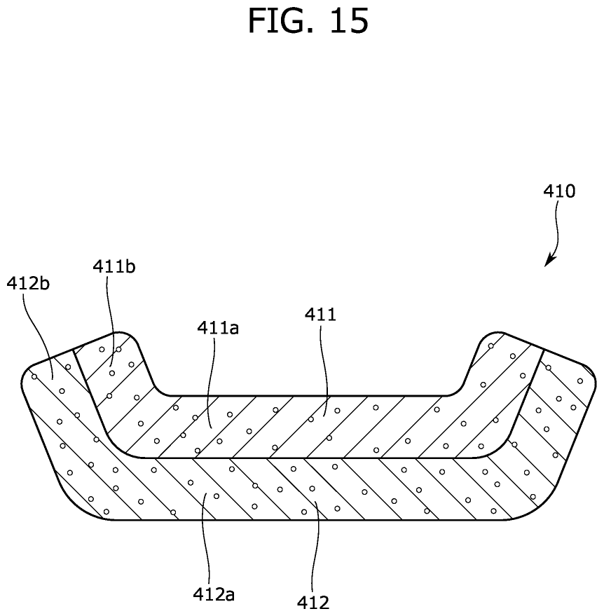

As shown in FIG. 15, the cushion member 410 includes a first cushion member 411 containing biomass urethane foam, and a second cushion member 412 disposed below the first cushion member 411 and supporting the first cushion member 411 from below.

The first cushion member 411 is a soft cushion member, and is made of, for example, biomass urethane foam. Here, the biomass urethane foam includes soft polyurethane foam with a high biomass ratio. Incidentally, in order to improve seating feeling, it is preferable that the soft cushion member has a high modulus of resilience and a low hardness.

The second cushion member 412 is a cushion deformation suppressing member that suppresses deformation of the first cushion member 411, and is, for example, a urethane base material molded by foam molding using a urethane foam material.

A hardness of the second cushion member 412 is higher than a hardness of the first cushion member 411. The second cushion member 412 has a higher hardness and elasticity than the first cushion member 411, and is less likely to bend, so that deformation of the first cushion member 411 with a lower hardness due to a load from the seated occupant can be suppressed.

As shown in FIG. 15, the first cushion member 411 includes a central body portion 411a that supports the buttocks of the seated occupant from below, and bulging portions 411b that bulge from both end portions of the central body portion 411a in a seat width direction toward a seated occupant side (upper side).

In addition, the second cushion member 412 includes a central support portion 412a that supports the buttocks of the seated occupant from below, and side support portions 412b that bulge from both end portions of the central support portion 412a in the seat width direction toward the seated occupant side (upper side).

As shown in FIG. 15, the first cushion member 411 is disposed to be closer to the seated occupant side than the second cushion member 412, and comes into contact with the second cushion member 412 to overlap the second cushion member 412 in a seat thickness direction.

Specifically, the central body portion 411a is supported from below by the central support portion 412a. The bulging portions 411b are supported from the outside in the seat width direction by the side support portions 412b.

In such a manner, in the cushion member 410, the first cushion member 411 with a low hardness is supported toward the seated occupant side by the second cushion member 412 with a high hardness, so that deformation (settling) of the first cushion member 411 due to a load from the seated occupant can be suppressed and the modulus of resilience can be increased.

In the above-described embodiment, the first cushion member 411 with a low hardness is disposed at a position close to the seated occupant. In consequence, seating comfort can be improved. In addition, the second cushion member 412 with high rigidity is disposed to surround the lower side and the outer side of the first cushion member 411. In consequence, deformation of the first cushion member 411 toward the lower side and the outer side can be suppressed.

Modification examples of the cushion member 410 will be described below.

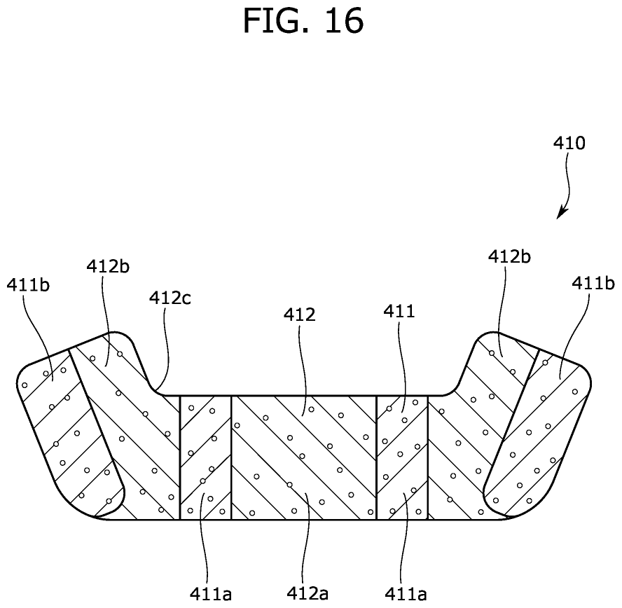

In Modification Example 1 shown in FIG. 16, the first cushion member 411 is disposed on the sides of the second cushion member 412, and comes into contact with the second cushion member 412 to overlap the second cushion member 412 in the seat width direction.

Specifically, the central body portions 411a are supported from the sides by the central support portion 412a. The bulging portions 411b are supported from the sides by the side support portions 412b.

The first cushion member 411 is provided at a position different from those of connecting portions 412c between the central support portion 412a and the side support portions 412b. Since the first cushion member 411 is provided at a position different from those of the connecting portions 412c of the second cushion member 412 on which stress is likely to concentrate, the occurrence that the first cushion member 411 with a low hardness is subjected to the concentration of stress and thus is deformed can be suppressed.

In the above-described embodiment, since the first cushion member 411 with a low hardness is supported from the sides by the second cushion member 412 with a high hardness, the occurrence that the first cushion member 411 deforms and spreads out to the sides due to a load from the seated occupant can be suppressed. Further, the occurrence that the first cushion member 411 is subjected to the concentration of stress and thus the first cushion member 411 is deformed can be suppressed.

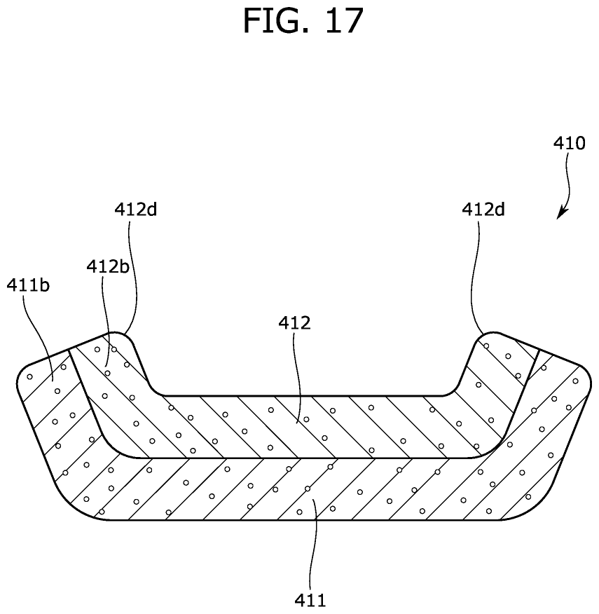

In Modification Example 2 shown in FIG. 17, the first cushion member 411 is disposed below the second cushion member 412, and comes into contact with the second cushion member 412 to overlap the second cushion member 412 in the seat thickness direction.

Specifically, the central body portion 411a is supported from above toward the seated occupant side by the central support portion 412a. The bulging portions 411b are supported from the sides by the side support portions 412b.

The first cushion member 411 is provided at a position different from those of corner portions 412d of the cushion member 410 (side support portions 412b). Since the first cushion member 411 is provided at a position different from those of the corner portions 412d of the second cushion member 412 with which the seated occupant is likely to come into contact, the occurrence that the first cushion member 411 is subjected to pressure and thus is deformed can be suppressed.

In the above-described embodiment, the first cushion member 411 with a low hardness is disposed at a position far from the seated occupant. In consequence, the occurrence that the first cushion member 411 directly receives a load from the seated occupant and thus is deformed can be suppressed. Further, deformation of the first cushion member 411 due to contact with the seated occupant can be suppressed.

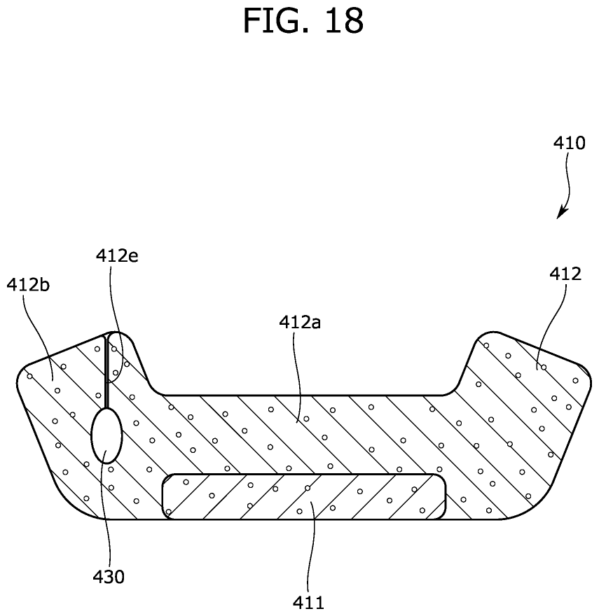

In Modification Example 3 shown in FIG. 18, the first cushion member 411 is disposed below the second cushion member 412, and comes into contact with the second cushion member 412 to overlap the second cushion member 412 in the seat thickness direction.

Specifically, the central body portion 411a is supported by the central support portion 412a such that an upper surface and side surfaces of the central body portion 411a are covered. Incidentally, the first cushion member 411 of the present modification example does not include the bulging portions 411b.

As shown in FIG. 18, the airbag module 430 is provided in the side support portion 412b of the second cushion member 412. In addition, a tear line 412e that is pushed out when the airbag is inflated is formed in the side support portion 412b of the second cushion member 412.

Here, the first cushion member 411 is provided at a position different from those of the airbag module 430 and the tear line 412e. Since the first cushion member 411 is disposed at a position away from the airbag module 430 and the tear line 412e, deformation of the first cushion member 411 due to pressure applied when the airbag module 430 is activated can be suppressed.

In addition, the first cushion member 411 is provided at a position different from those of the side support portions 412b of the second cushion member 412. The side support portions 412b are likely to receive a larger load than the central support portion 412a. For that reason, the first cushion member 411 is disposed at a position different from those of the side support portions 412b, so that deformation of the first cushion member 411 due to the load of the seated occupant can be suppressed.

In the above-described embodiment, the first cushion member 411 with a low hardness is disposed at a position far from the seated occupant. In consequence, the occurrence that the first cushion member 411 directly receives a load from the seated occupant and thus is deformed can be suppressed. Further, the first cushion member 411 is not disposed on the side support portions 412b. In consequence, deformation of the first cushion member 411 due to a load from the seated occupant or the airbag module 430 can be suppressed.

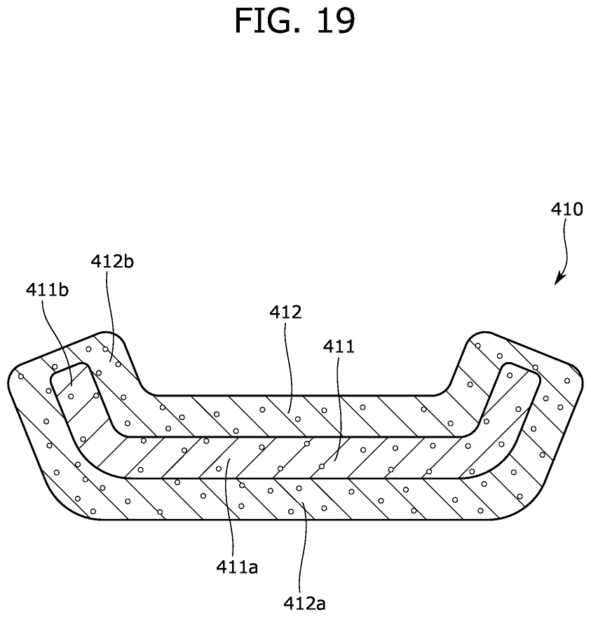

In Modification Example 4 shown in FIG. 19, the first cushion member 411 is disposed such that the periphery of the first cushion member 411 is covered with the second cushion member 412. In other words, the second cushion member 412 accommodates the first cushion member 411 inside. Specifically, the central body portion 411a is covered with the central support portion 412a, and the bulging portions 411b are covered with the side support portions 412b.

In the above-described embodiment, the first cushion member 411 with a low hardness is not exposed on a surface of the cushion member 410 (second cushion member 412). For that reason, deformation of the first cushion member 411 due to direct reception of a load from the seated occupant can be suppressed.

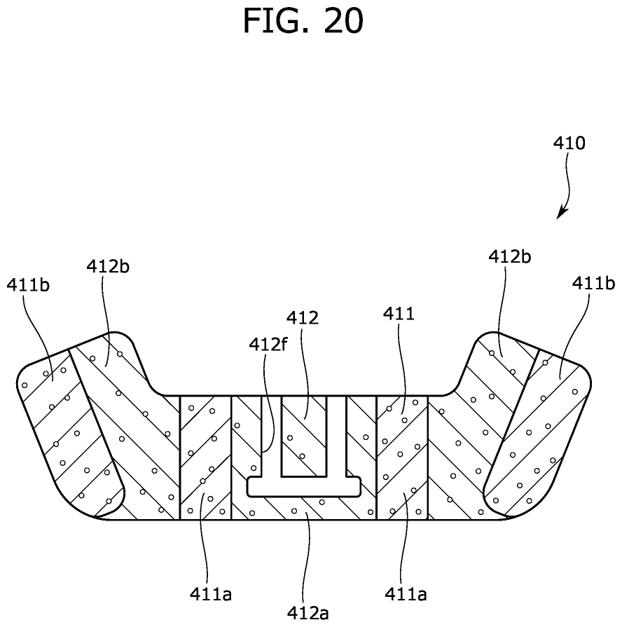

In Modification Example 5 shown in FIG. 20, the first cushion member 411 is disposed on the sides of the second cushion member 412, and comes into contact with the second cushion member 412 to overlap the second cushion member 412 in the seat width direction.

In the present modification example, the description of the same configurations as the cushion member 410 and the cushion frame 420 of Modification Examples 1 to 4 will be omitted. Incidentally, in Modification Examples 6 to 12 to be described later, the description of the same configurations will also be omitted.

As shown in FIG. 20, a ventilation passage 412f having a recessed shape and configured to pass air blown from the outlet of the blower device 450 is formed in the central support portion 412a of the second cushion member 412. The ventilation passage 412f allows the air to be blown toward the seated occupant over substantially the entirety of a central portion of the seat cushion 402.

As shown in FIG. 20, the first cushion member 411 is provided at a position different from that of the ventilation passage 412f. Since the ventilation passage 412f is hollow, the ventilation passage 412f is easily deformed by the passing of the air. For that reason, the first cushion member 411 is disposed at a position away from the ventilation passage 412f, so that deformation of the first cushion member 411 due to the influence of the ventilation passage 412f can be suppressed.

In the above-described embodiment, the first cushion member 411 with a low hardness is supported from the sides by the second cushion member 412 with a high hardness. In consequence, the occurrence that the first cushion member 411 deforms and spreads out to the sides due to a load from the seated occupant can be suppressed. Further, deformation of the first cushion member 411 due to the influence of the ventilation passage 412f can be suppressed.

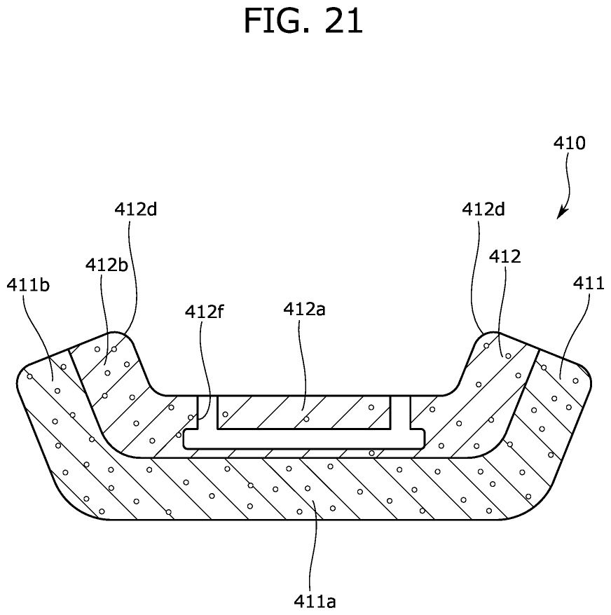

In Modification Example 6 shown in FIG. 21, the first cushion member 411 is disposed below the second cushion member 412, and comes into contact with the second cushion member 412 to overlap the second cushion member 412 in the seat thickness direction.

Incidentally, the present modification example has a configuration in which the ventilation passage 412f shown in FIG. 20 is formed in the cushion member 410 shown in FIG. 17.

In the above-described embodiment, the first cushion member 411 with a low hardness is disposed at a position far from the seated occupant. In consequence, the occurrence that the first cushion member 411 directly receives a load from the seated occupant and thus is deformed can be suppressed. Further, deformation of the first cushion member 411 due to the influence of the ventilation passage 412f can be suppressed.

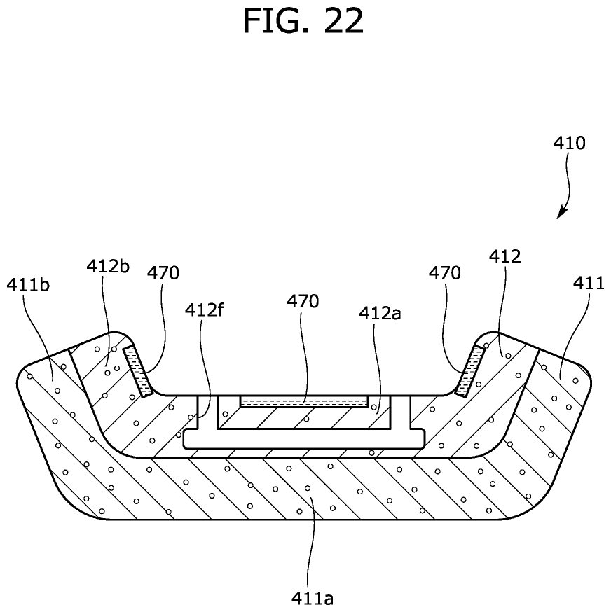

In Modification Example 7 shown in FIG. 22, the first cushion member 411 is disposed below the second cushion member 412, and comes into contact with the second cushion member 412 to overlap the second cushion member 412 in the seat thickness direction.

The temperature adjustment units 470 are, for example, heating devices such as heaters, and are provided on surfaces on the seated occupant side of the central support portion 412a and the side support portions 412b of the second cushion member 412.

Incidentally, in the present modification example, the seated occupant is warmed by heater plates; however, the present invention is not limited thereto, and the seated occupant may be cooled by cooler plates.

As shown in FIG. 22, the first cushion member 411 is provided at a position different from those of the temperature adjustment units 470. Since the first cushion member 411 is disposed at a position away from the temperature adjustment units 470, deformation of the first cushion member 411 due to the influence of heat or the like generated when the temperature adjustment units 470 are activated can be suppressed.

In the above-described embodiment, the first cushion member 411 with a low hardness is disposed at a position far from the seated occupant. In consequence, the occurrence that the first cushion member 411 directly receives a load from the seated occupant and thus is deformed can be suppressed. Further, deformation of the first cushion member 411 due to the influence of the ventilation passage 412f or the temperature adjustment units 470 can be suppressed.

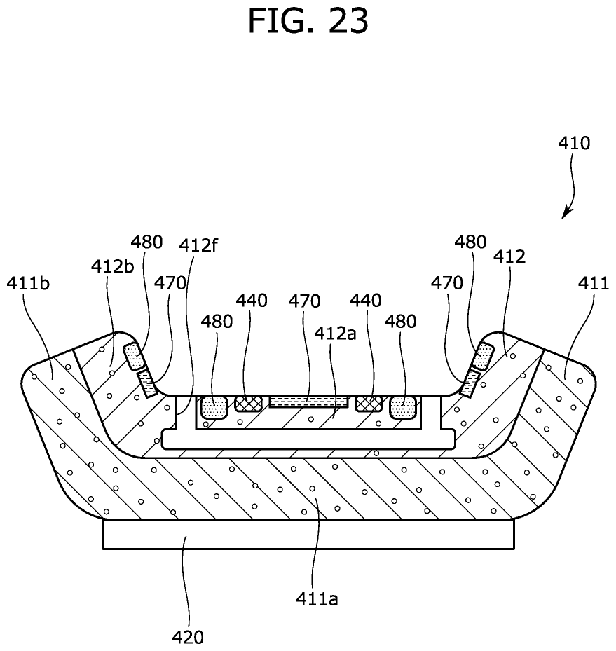

In Modification Example 8 shown in FIG. 23, the first cushion member 411 is disposed below the second cushion member 412, and comes into contact with the second cushion member 412 to overlap the second cushion member 412 in the seat thickness direction.

As shown in FIG. 23, the cushion frame 420 is made of a substantially rectangular frame-shaped body, and is a support member that supports the cushion member 410 from below.

The first cushion member 411 is disposed above the cushion frame 420, and comes into contact with the cushion frame 420 to overlap the cushion frame 420 in the seat thickness direction. The cushion frame 420 is a cushion deformation suppressing member that suppresses deformation of the first cushion member 411 by supporting the first cushion member 411 from below.

Incidentally, the present modification example has a configuration in which the cushion frame 420 supports the cushion member 410; however, the present invention is not limited thereto. For example, a configuration in which an elastic member (a spring, a wire, or the like) that supports the seated occupant supports the cushion member 410 may be adopted.

As shown in FIG. 23, the detection sensors 440 and the notification units 480 are provided on the surfaces on the seated occupant side of the central support portion 412a and the side support portions 412b of the second cushion member 412.

Here, the first cushion member 411 is provided at a position different from those of the detection sensors 440 or the notification units 480. Since the first cushion member 411 is disposed at a position away from the detection sensors 440 or the notification units 480, deformation of the first cushion member 411 due to the influence of heat, vibration, or the like generated when the detection sensors 440 or the notification units 480 are activated can be suppressed.

In the above-described embodiment, the first cushion member 411 with a low hardness is disposed at a position far from the seated occupant. In consequence, the occurrence that the first cushion member 411 directly receives a load from the seated occupant and thus is deformed can be suppressed. Further, deformation of the first cushion member 411 due to the influence of the ventilation passage 412f, the detection sensors 440, the temperature adjustment units 470, or the notification units 480 can be suppressed.

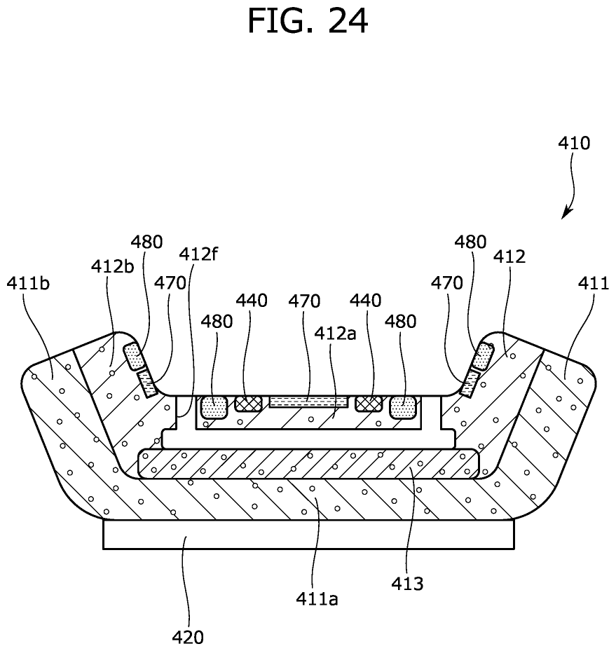

In Modification Example 9 shown in FIG. 24, the cushion member 410 includes the first cushion member 411; the second cushion member 412 disposed above the first cushion member 411; and a third cushion member 413 disposed between the first cushion member 411 and the second cushion member 412.

The third cushion member 413 is a cushion deformation suppressing member that suppresses deformation of the first cushion member 411, and is, for example, a mesh structure made of three-dimensional reinforcing fibers or the like.

A hardness of the third cushion member 413 is higher than hardnesses of the first cushion member 411 and the second cushion member 412. The third cushion member 413 has a higher hardness and elasticity than the first cushion member 411 and the second cushion member 412, and is less likely to bend, so that deformation of the first cushion member 411 with a lower hardness due to a load from the seated occupant can be suppressed.

In the above-described embodiment, the first cushion member 411 with a low hardness is disposed at a position farther from the seated occupant than the second cushion member 412 with a high hardness. Then, the third cushion member 413 with a high hardness is disposed between the first cushion member 411 and the second cushion member 412 to come into contact with the first cushion member 411 from above. In consequence, the occurrence that the first cushion member 411 directly receives a load from the seated occupant and thus is deformed can be suppressed.

Further, deformation of the first cushion member 411 due to the influence of the ventilation passage 412f, the detection sensors 440, the temperature adjustment units 470, or the notification units 480 can be suppressed.

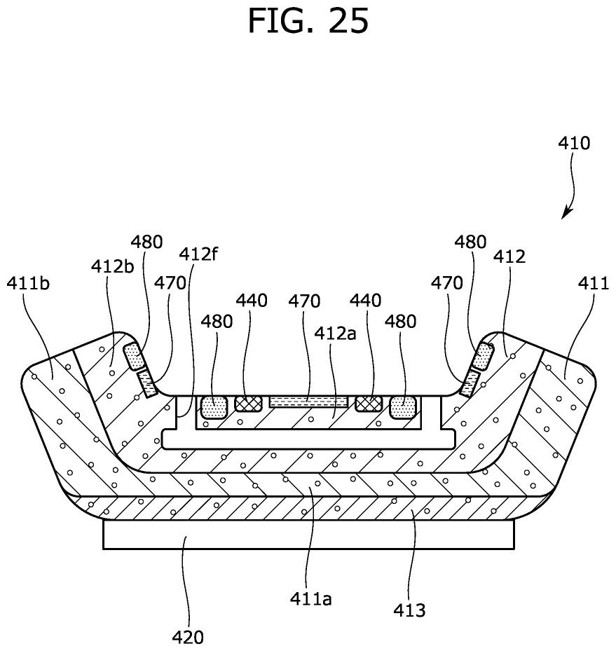

In Modification Example 10 shown in FIG. 25, the cushion member 410 includes the first cushion member 411; the second cushion member 412 disposed above the first cushion member 411; and the third cushion member 413 disposed below the first cushion member 411.

In the above-described embodiment, the first cushion member 411 with a low hardness is disposed at a position farther from the seated occupant than the second cushion member 412 with a high hardness. Then, the third cushion member 413 with a high hardness is disposed to come into contact with the first cushion member 411 from below. In consequence, the occurrence that the first cushion member 411 directly receives a load from the seated occupant and thus is deformed can be suppressed.

Further, deformation of the first cushion member 411 due to the influence of the ventilation passage 412f, the detection sensors 440, the temperature adjustment units 470, or the notification units 480 can be suppressed.

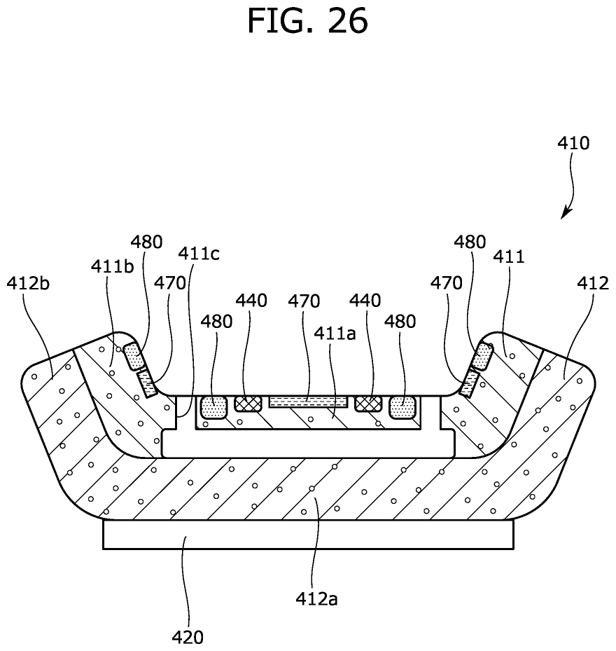

In Modification Example 11 shown in FIG. 26, the first cushion member 411 is disposed above the second cushion member 412, and comes into contact with the second cushion member 412 to overlap the second cushion member 412 in the seat thickness direction.

Incidentally, the present modification example has a configuration in which the cushion frame 420, the detection sensors 440, the temperature adjustment units 470, and the notification units 480 shown in FIG. 25 are provided on the cushion member 410 shown in FIG. 15.

As shown in FIG. 26, a ventilation passage 411c having a recessed shape and configured to pass air blown from the outlet of the blower device 450 is formed in the central body portion 411a of the first cushion member 411. The ventilation passage 411c allows the air to be blown toward the seated occupant over substantially the entirety of the central portion of the seat cushion 402.

The ventilation passage 411c is formed on a surface mating with the second cushion member 412 among the surfaces of the first cushion member 411. For that reason, it becomes easy to form the ventilation passage 411c when the cushion member 410 is manufactured.

In the above-described embodiment, the first cushion member 411 with a low hardness is disposed at a position close to the seated occupant. In consequence, seating comfort can be improved. In addition, the second cushion member 412 with high rigidity is disposed to surround the lower side and the outer side of the first cushion member 411. In consequence, deformation of the first cushion member 411 toward the lower side and the outer side can be suppressed.

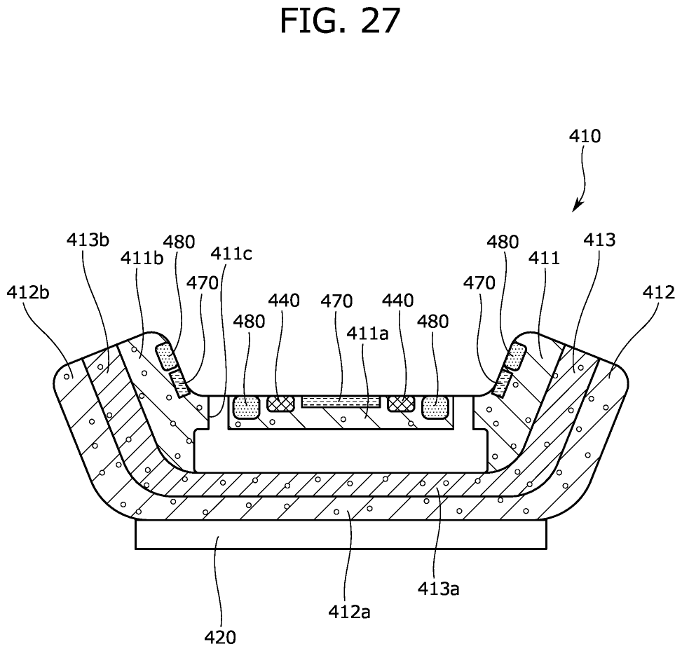

In Modification Example 12 shown in FIG. 27, the cushion member 410 includes the first cushion member 411; the second cushion member 412 disposed below the first cushion member 411; and the third cushion member 413 disposed between the first cushion member 411 and the second cushion member 412.

As shown in FIG. 27, the third cushion member 413 includes a central portion 413a that supports the buttocks of the seated occupant from below, and side portions 413b that bulge from both end portions of the central portion 413a in the seat width direction toward the seated occupant side (upward).

As shown in FIG. 27, the third cushion member 413 is disposed below the first cushion member 411, and comes into contact with the first cushion member 411 to overlap the first cushion member 411 in the seat thickness direction. Specifically, the central body portion 411a is supported from below by the central portion 413a. The bulging portions 411b are supported from the outside in the seat thickness direction by the side portions 413b.

In the above-described embodiment, the first cushion member 411 with a low hardness is disposed at a position close to the seated occupant. In consequence, seating comfort can be improved.

In addition, the second cushion member 412 with high rigidity and the third cushion member 413 with high rigidity are disposed to surround the lower side and the outer side of the first cushion member 411. In consequence, deformation of the first cushion member 411 toward the lower side and the outer side can be suppressed.

### <<Detection Sensor>>

As shown in FIGS. 23 to 28, each of the detection sensors 440 is a sheet-shaped pressure sensor that detects a seating pressure applied to a seating surface of the seat cushion 2 when the seated occupant is seated in the seat, and is attached to the cushion member 410 via a sensor attachment portion (not shown).

Here, “seating pressure” is a value that changes periodically according to the physiological activity of the seated occupant, specifically, breathing in a state where the seated occupant is seated on the seat cushion 402, and is a target value detected by the pressure sensor. Namely, “seating pressure” corresponds to a “biological signal (biological information) of the seated occupant”.

Incidentally, the detection sensor 440 may be a seating sensor that turns on or off depending on the seating pressure of the seated occupant. Preferably, the detection sensor 440 is a push switch type seating sensor. The detection sensor 440 detects a seating pressure, and outputs a detection signal based on the detection result of the seating pressure.

### <<Notification Unit>>

As shown in FIGS. 23 to 28, the notification units 480 make a notification about the state of the seated occupant, and are attached to the cushion member 410. The notification units 480 include, for example, a vibration generation unit, a sound generation unit, and a light generation unit.

The vibration generation unit is, for example, a device vibration motor that starts vibration upon including a receiving a signal from the control device 460. The vibration generation unit can notify the seated occupant of a warning or the like by applying stimulation to the back or buttocks of the seated occupant.

The sound generation unit is, for example, a device including a speaker that outputs a predetermined sound upon receiving a signal from the control device 460. The sound generation unit can notify the seated occupant of a warning or the like by generating sound from the speaker.

The light generation unit is, for example, a device including an LED that emits light upon receiving a signal from the control device 460. The light generation unit can notify the seated occupant of a warning or the like by causing the LED to emit light.

### <<Blower Device>>

As shown in FIGS. 23 to 28, the blower device 450 blows air toward the seated occupant side, and is attached to the cushion frame 420.

The blower device 450 includes a blower body disposed on the front side of the cushion frame 420 in the seat front to rear direction; a duct extending rearward from the blower body; and the outlet provided at a tip portion of the duct. The outlet is an air blowing port that blows the air toward the seated occupant, and communicates with the ventilation passages 411c and 412f of the cushion member 410.

The air blown from the outlet of the blower device 450 passes through the ventilation passages 411c and 412f of the cushion member 410, and the air is blown toward the seated occupant side.

### <<Control Device>>

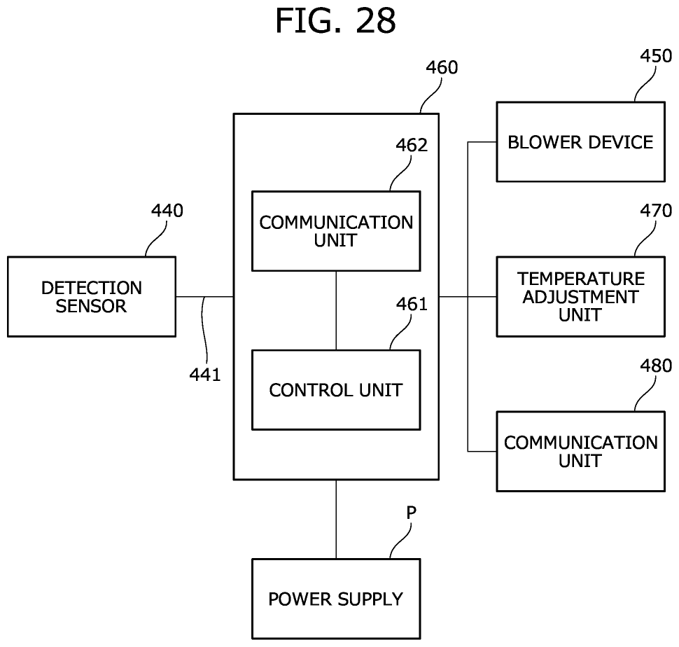

As shown in FIG. 28, the control device 460 is a device that processes the biological signals detected by the detection sensors 440, and is attached to a bottom surface of the cushion frame 420 via a holder. The control device 460 is electrically connected to the detection sensors 440 by a harness 441 extending from the detection sensors 440. Incidentally, the connection between the control device 460 and the detection sensors 440 is not limited to wired communication through the harness 441, and may be wireless communication.

The control device 460 includes a control unit 461 that performs processing based on the biological signals detected by the detection sensors 440, and a communication unit 462 that receives the biological signals detected by the detection sensors 440 and that wirelessly transmits the biological signals to the outside.

The control unit 461 corresponds to a microcomputer, and comprehensively executes electrical control.

The communication unit 462 is connected to an external terminal, for example, a tablet terminal, a smartphone, a computer such as PC, an electrical device using a wireless communication technology, and transmits and receives electrical signals (data signals).

The control device 460 receives a supply of electric power from the power supply P installed in the conveyance.

Incidentally, the control device 460 may be attached inside the conveyance seat S5, or may be attached outside the conveyance seat S5.

In the above-described configuration, the control device 460 is connected to the notification units 480 through a network, and controls the notification units 480 to make a notification (for example, a warning g for seat belt fastening, a warning when an abnormality occurs in the heart rate change, or the like) to the seated occupant by generating vibration or sound or emitting light based on the biological signals detected by the detection sensors 440.

### <<Supplementary Notes>>

According to the conveyance seat S5, a conveyance seat may include a pad material and a skin material covering the pad material. The pad material may include a first cushion member containing biomass urethane foam. The conveyance seat may include a cushion deformation suppressing member that suppresses a deformation of the first cushion member.

With the above-described configuration, deformation (settling) of the cushion member with a low hardness due to a load from a seated occupant can be suppressed.

In this configuration, the cushion deformation suppressing member may be a second cushion member, and a hardness of the second cushion member may be higher than a hardness of the first cushion member.

With the above-described configuration, deformation (settling) of the cushion member with a low hardness due to a load from the seated occupant can be even further suppressed.

In this configuration, the second cushion member may be provided to be closer to a seated occupant side than the first cushion member.

With the above-described configuration, the occurrence that the cushion member with a low hardness deforms and spreads out to the sides due to a load from the seated occupant can be suppressed.

In this configuration, the second cushion member may include a central support portion that supports buttocks or a back of a seated occupant, and side support portions that bulge from both end portions of the central support portion in a seat width direction toward a seated occupant side. The first cushion member may be provided at a position different from positions of the side support portions inside the conveyance seat.

With the above-described configuration, the occurrence that the cushion member with a low hardness is subjected to large pressure and thus is deformed can be suppressed.

In this configuration, the second cushion member may include a central support portion that supports buttocks or a back of a seated occupant, and side support portions that bulge from both end portions of the central support portion in a seat width direction toward a seated occupant side. The first cushion member may be provided at a position different from positions of connecting portions between the central support portion and the side support portions inside the conveyance seat.

With the above-described configuration, the occurrence that the cushion member with a low hardness is subjected to pressure due to contact with the seated occupant and thus is deformed can be suppressed.

In this configuration, the first cushion member may be provided at a position different from a position of a surface on a seated occupant side inside the conveyance seat.

With the above-described configuration, the cushion member with a low hardness does not directly receive a load from the seated occupant, and deformation of the cushion member with a low hardness can be even further suppressed.

In this configuration, the conveyance seat may include a seat frame serving as a skeleton; and a blower device attached to the seat frame to blow air toward a seated occupant side. The second cushion member may have a ventilation passage having a recessed shape and configured to pass the air blown from an outlet of the blower device. The first cushion member may be provided at a position different from a position of the ventilation passage inside the conveyance seat.

With the above-described configuration, deformation of the cushion member with a low hardness due to the influence of the ventilation passage can be suppressed.

In this configuration, the conveyance seat may include a temperature adjustment unit disposed between the pad material and the skin material to adjust a temperature of the skin material. The second cushion member may be provided to be closer to a seated occupant side than the first cushion member. The temperature adjustment unit may be provided on a surface on the seated occupant side of the second cushion member. The first cushion member may be provided at a position different from a position of the temperature adjustment unit inside the conveyance seat.

With the above-described configuration, deformation of the cushion member with a low hardness due to the influence of heat or the like generated when the temperature adjustment unit is activated can be suppressed.

In this configuration, the conveyance seat may include a notification unit disposed between the pad material and the skin material to make a notification about a state of a seated occupant. The second cushion member may be provided to be closer to a seated occupant side than the first cushion member. The notification unit may be provided on a surface on the seated occupant side of the second cushion member. The first cushion member may be provided at a position different from a position of the notification unit inside the conveyance seat.

With the above-described configuration, deformation of the cushion member with a low hardness due to the influence of vibration generated when a vibration generation unit or a sound generation unit of the notification unit is activated or the influence of heat generated when a light generation unit is activated can be suppressed.

In this configuration, the conveyance seat may include a detection sensor disposed between the pad material and the skin material to detect a state of a seated occupant. The second cushion member may be provided to be closer to a seated occupant side than the first cushion member. The detection sensor may be provided on a surface on the seated occupant side of the second cushion member. The first cushion member may be provided at a position different from a position of the detection sensor inside the conveyance seat.

With the above-described configuration, deformation of the cushion member with a low hardness due to the influence of heat or the like generated when the detection sensor is activated can be suppressed.

In this configuration, the conveyance seat may include a seat frame serving as a skeleton, and an airbag module attached to the seat frame to store an airbag. The second cushion member may include a central support portion that supports buttocks or a back of a seated occupant, and side support portions that bulge from both end portions of the central support portion in a seat width direction toward a seated occupant side. The side support portion may have a tear line that is pushed out by the airbag when the airbag is inflated. The first cushion member may be provided at a position different from a position of the tear line inside the conveyance seat.

With the above-described configuration, deformation of the cushion member with a low hardness due to pressure applied when the airbag module is activated can be suppressed.

### Sixth Embodiment

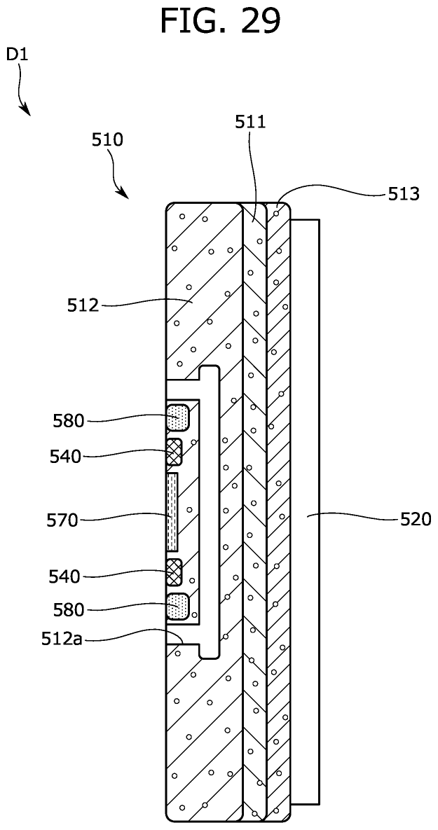

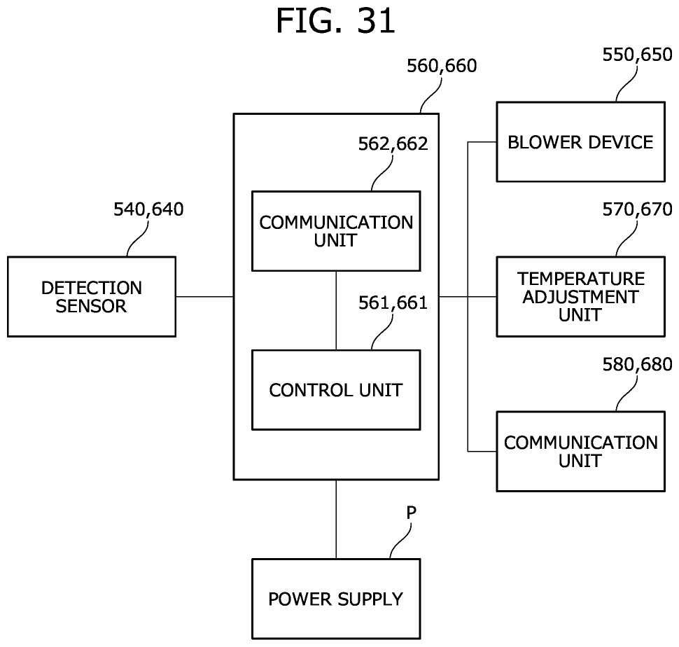

Next, a door lining D1 of a sixth embodiment will be described based on FIGS. 29 to 31.

Incidentally, the description of contents that overlap with those of the conveyance seats S1 to S5 described above will be omitted. The door lining D1 of the sixth embodiment differs from the conveyance seats S1 to S5 mainly in the configuration of a cushion member 510.

### <<Overall Configuration of Door Lining>>

As shown in FIGS. 29 to 31, the door lining D1 of the sixth embodiment is a vehicle door lining, and includes a door body including the cushion member 510 and a door frame 520; detection sensors 540 that detect biological signals of a seated occupant; a blower device 550 that blows air toward the seated occupant; a control device 560 that receives the biological signals detected by the detection sensors 540 and that controls the blower device 550; a temperature adjustment unit 570 that adjusts the temperature of the door body; and notification units 580 that make a notification about the state of the seated occupant.

The door lining D1 is configured by covering the cushion member 510 with a skin material (not shown).

In addition, in the door lining D1, a front end portion of the door frame 520 is rotatably attached to a vehicle body via a hinge.

For that reason, a connection member for various electrical components provided on the door lining D1 extends toward a front end portion of the door lining D1. Further, the connection member is connected to the power supply P (power supply system) provided on the vehicle body.

### <<Cushion Member>>

As shown in FIG. 29, the cushion member 510 includes a first cushion member 511 containing biomass urethane foam; a second cushion member 512 disposed on a vehicle interior side of the first cushion member 511; and a third cushion member 513 disposed on a vehicle exterior side of the first cushion member 411.

The third cushion member 513 is a cushion deformation suppressing member that suppresses deformation of the first cushion member 511, and is, for example, a mesh structure made of three-dimensional reinforcing fibers or the like.

A hardness of the third cushion member 513 is higher than hardnesses of the first cushion member 511 and the second cushion member 512. The third cushion member 513 has a higher hardness and elasticity than the first cushion member 511 and the second cushion member 512, and is less likely to bend, so that deformation of the first cushion member 411 with a lower hardness due to a load from the seated occupant can be suppressed.

As shown in FIG. 29, the door frame 520 is made of a substantially rectangular frame-shaped body, and is a support member that supports the cushion member 510 from the side.

The third cushion member 513 is disposed on the vehicle interior side of the door frame 520, and comes into contact with the door frame 520 to overlap the door frame 520 in a vehicle body width direction. The door frame 520 is a cushion deformation suppressing member that suppresses deformation of the first cushion member 511 by supporting the first cushion member 411 from the side.

As shown in FIG. 29, the detection sensors 540, the temperature adjustment unit 570, and the notification units 580 are provided on a surface on the vehicle interior side of the second cushion member 412.

Here, the first cushion member 511 is provided at a position different from those of the detection sensors 540. Specifically, the first cushion member 511 is disposed at a position away from the detection sensors 540, the temperature adjustment unit 570, and the notification units 580. In consequence, deformation of the first cushion member 511 due to the influence of heat, vibration, or the like generated when the detection sensors 540, the temperature adjustment unit 570, or the notification units 580 are activated can be suppressed.

As shown in FIG. 29, a ventilation passage 512a having a recessed shape and configured to pass the air blown from an outlet of the blower device 550 is formed in the second cushion member 512. The ventilation passage 512a allows the air to be blown toward the seated occupant.

As shown in FIG. 29, the first cushion member 511 is provided at a position different from that of the ventilation passage 512a. Since the ventilation passage 512a is hollow, the ventilation passage 512a is easily deformed by the passing of the air. For that reason, the first cushion member 511 is disposed at a position away from the ventilation passage 512a, so that deformation of the first cushion member 511 due to the influence of the ventilation passage 512a can be suppressed.

In such a manner, in the cushion member 510, the first cushion member 411 with a low hardness is supported from the sides by the second cushion member 512 with a high hardness and the third cushion member 513 with a high hardness, so that deformation (settling) of the first cushion member 411 due to a load from the seated occupant can be suppressed and the modulus of resilience can be increased.

In the above-described embodiment, the first cushion member 511 with a low hardness is disposed on the vehicle exterior side (a position far from the seated occupant). In consequence, the occurrence that the first cushion member 411 directly receives a load from the seated occupant and thus is deformed can be suppressed.

Further, deformation of the first cushion member 511 due to the influence of the ventilation passage 512a, the detection sensors 540, the temperature adjustment unit 570, or the notification units 580 can be suppressed.

A modification example of the door lining D1 will be described below.

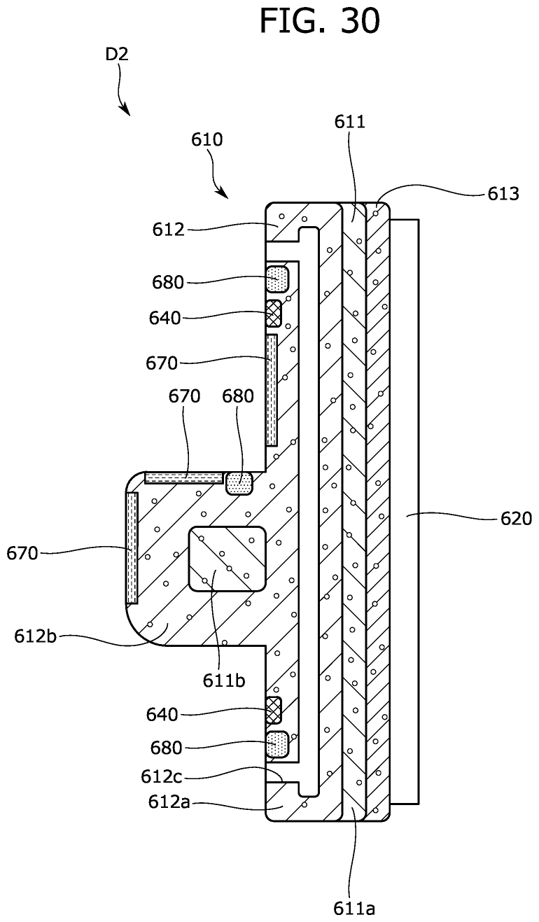

Since a door lining D2 of a modification example shown in FIG. 30 has a configuration in which an armrest is formed on the cushion member 510 shown in FIG. 29, the description of the same configurations will be omitted.

As shown in FIG. 30, a first cushion member 611 includes a door-side body portion 611a disposed to come into contact with a door frame 620, and an armrest bulging portion 611b constituting the armrest.

A second cushion member 612 includes a door-side support portion 612a disposed to come into contact with the door-side body portion 611a, and an arm support portion 612b constituting the armrest.

As shown in FIG. 30, a ventilation passage 612c having a recessed shape and configured to pass air blown from an outlet of a blower device 650 is formed in the door-side body portion 611a.

The arm support portion 612b accommodates the armrest bulging portion 611b inside.

As shown in FIG. 30, detection sensors 640, temperature adjustment units 670, and notification units 680 are provided on a surface on the seated occupant side of the second cushion member 612.

Here, the first cushion member 611 is provided at a position different from those of the detection sensors 640, the temperature adjustment units 670, and the notification units 680. Since the first cushion member 611 is disposed at a position away from the detection sensors 640, the temperature adjustment units 670, or the notification units 680, deformation of the first cushion member 611 due to the influence of heat, vibration, or the like generated when the detection sensors 640, the temperature adjustment units 670, and the notification units 680 are activated can be suppressed.

In the above-described embodiment, the first cushion member 611 with a low hardness is disposed at a position far from the seated occupant. In consequence, the occurrence that the first cushion member 411 directly receives a load from the seated occupant and thus is deformed can be suppressed.

Further, deformation of the first cushion member 611 due to the influence of the ventilation passage 612c, the detection sensors 640, the temperature adjustment units 670, or the notification units 680 can be suppressed.

### Seventh Embodiment

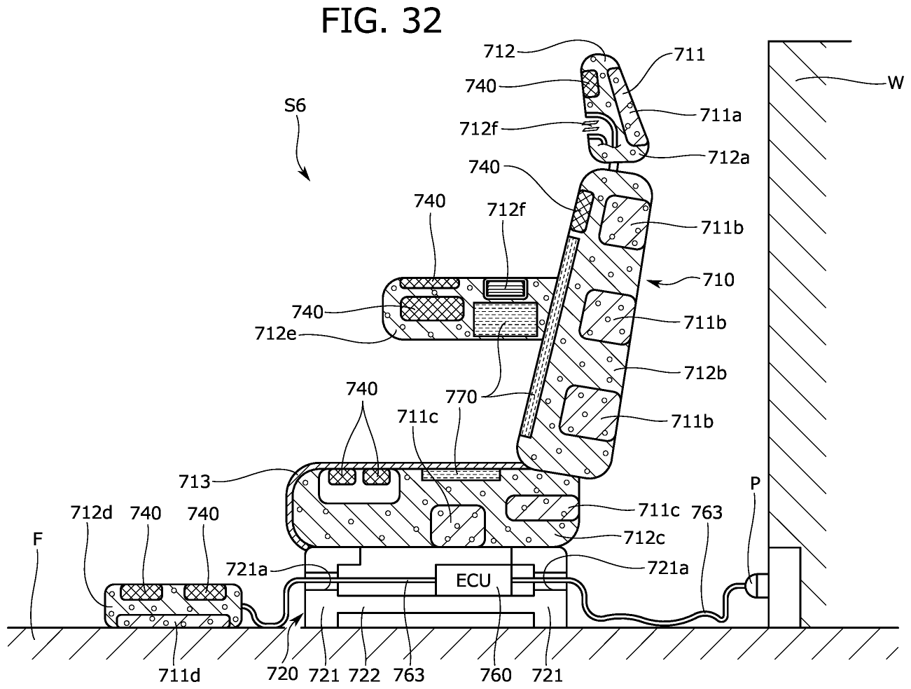

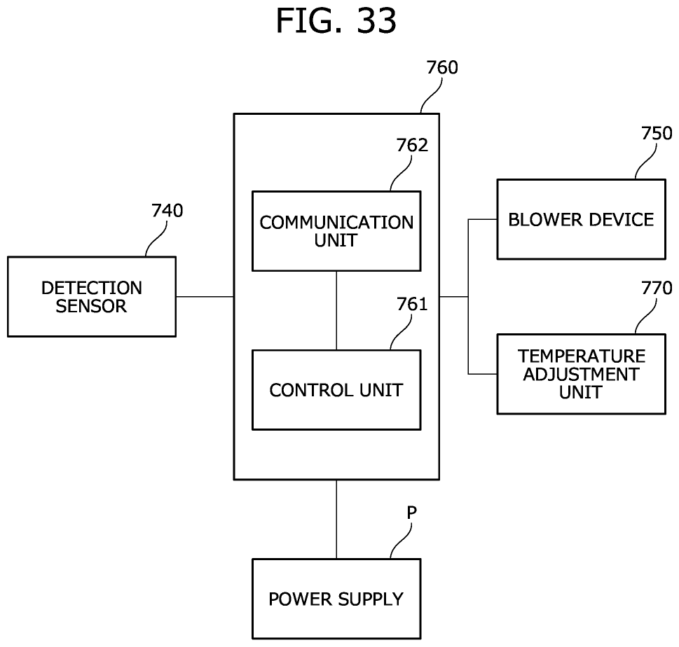

Next, a seat S6 of a seventh embodiment will be described based on FIGS. 32 and 33.

Incidentally, the description of contents that overlap with those of the conveyance seats S1 to S5 and the door linings D1 and D2 described above will be omitted.

The seat S6 of the seventh embodiment differs from the conveyance seats S1 to S5 mainly in the configurations of a cushion member 710 and a cushion frame 720.

### <<Overall Configuration of Seat>>

As shown in FIGS. 32 and 33, the seat S6 of the seventh embodiment is a seat, and includes a seat body including the cushion member 710 and the cushion frame 720; detection sensors 740 that detect biological signals of a seated occupant seated in the seat body; a blower device 750 that blows air toward the seated occupant; a control device 760 that receives the biological signals detected by the detection sensors 740 and that controls the blower device 750; and temperature adjustment units 770 that adjust the temperature of the seat body.

The seat S6 is configured by covering the cushion member 710 with a skin material (not shown).

Incidentally, the control device 460 can also transmit the biological signal to the outside.

### <<Cushion Member>>

As shown in FIG. 32, the cushion member 710 includes a first cushion member 711 containing biomass urethane foam; a second cushion member 712 that accommodates the first cushion member 711 inside; and a protection cover 713 that protects a seating surface of the first cushion member 711.

As shown in FIG. 32, the first cushion member 711 includes a headrest portion 711a that supports the head of the seated occupant from behind; a backrest portion 711b that supports the back of the seated occupant from behind; a seat portion 711c that supports the buttocks of the seated occupant from below; and a footrest portion 711d that supports the feet of the seated occupant from below.

In addition, the second cushion member 712 includes a headrest body portion 712a that supports the head of the seated occupant from behind; a backrest body portion 712b that supports the back of the seated occupant from behind; a seat body portion 712c that supports the buttocks of the seated occupant from below; a footrest body portion 712d that supports the feet of the seated occupant from below; and an armrest body portion 712e that supports the arm of the seated occupant from below.

As shown in FIG. 32, the headrest portion 711a is disposed behind the headrest body portion 712a, and comes into contact with the headrest body portion 712a to overlap the headrest body portion 712a in the seat thickness direction.

The backrest portion 711b is disposed behind the backrest body portion 712b, and comes into contact with the backrest body portion 712b to overlap the backrest body portion 712b in the seat thickness direction.

The seat portion 711c is disposed below the seat body portion 712c, and comes into contact with the seat body portion 712c to overlap the seat body portion 712c in the seat thickness direction.

The footrest portion 711d is disposed below the footrest body portion 712d, and comes into contact with the footrest body portion 712d to overlap the footrest body portion 712d in the seat thickness direction. The footrest body portion 712d is installed on a floor F and supports the feet of the seated occupant from below.

Incidentally, the first cushion member 711 is not disposed on the armrest body portion 712e.

As shown in FIG. 32, outlets 712f of the blower device 750 are formed in the headrest body portion 712a and the armrest body portion 712e.

Here, the first cushion member 711 is provided at a position different from those of the outlets 712f. Since the first cushion member 711 is disposed at a position away from the outlets 712f, deformation of the first cushion member 711 due to the influence of heat, vibration, or the like generated when the blower device 750 is activated can be suppressed.

As shown in FIG. 32, the cushion frame 720 is made of a substantially rectangular frame-shaped body, and is a support member that supports the cushion member 710 from below. The cushion frame 720 is a cushion deformation suppressing member that suppresses deformation of the first cushion member 711 (seat portion 711c) by supporting the seat portion 711c from below.

As shown in FIG. 32, the cushion frame 720 includes a plurality of leg portions 721 that support the seat portion 711c from below, and a placement portion 722 bridging between the plurality of leg portions 721. Harness insertion holes 721a into which a harness 763 extending from the control device 760 placed on the placement portion 722 is inserted are formed in the leg portions 721. Incidentally, the harness 763 is connected to the power supply P (power supply system) provided on a wall W.

Incidentally, the headrest body portion 712a, the backrest body portion 712b, the seat body portion 712c, the footrest body portion 712d, and the armrest body portion 712e are connected to the control device 760 via the harness 763 (partially not shown).

As shown in FIG. 32, detection sensors 740 and temperature adjustment units 770 are provided on a surface on the seated occupant side of the second cushion member 712.

Here, the first cushion member 611 is provided at a position different from those of the detection sensors 740 and the temperature adjustment units 770. Since the first cushion member 711 is disposed at a position away from the detection sensors 740 or the temperature adjustment units 770, deformation of the first cushion member 711 due to the influence of heat, vibration, or the like generated when the detection sensors 740 or the temperature adjustment units 770 are activated can be suppressed.

In such a manner, in the cushion member 710, the second cushion member 712 with high rigidity is disposed to surround the seated occupant side of the first cushion member 711, so that deformation of the first cushion member 411 toward the lower side and the rear side can be suppressed.

In the above-described embodiment, since the first cushion member 711 with a low hardness is disposed at a position far from the seated occupant, the first cushion member 711 does not directly receive a load from the seated occupant, and deformation of the first cushion member 711 can be even further suppressed. In addition, since the first cushion member 711 is disposed at a position different from that of the armrest body portion 712e that is likely to receive a large load, deformation of the first cushion member 711 due to the load of the seated occupant can be suppressed. Further, deformation of the first cushion member 711 due to the influence of the outlets 712f, the detection sensors 740, or the temperature adjustment units 770 can be suppressed.

### Eighth Embodiment

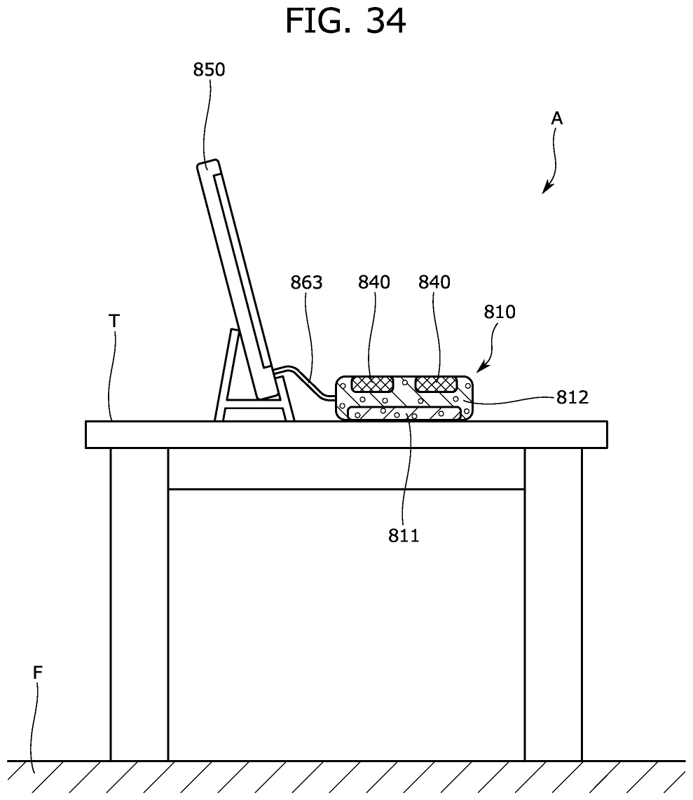

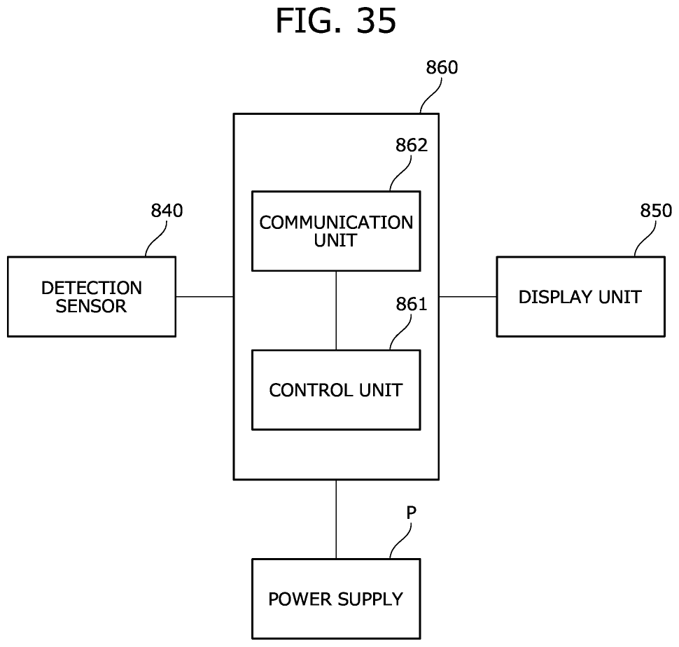

Next, an arm seat A of an eighth embodiment will be described based on FIGS. 34 and 35.

Incidentally, the description of contents that overlap with those of the conveyance seats S1 to S5, the door linings D1 and D2, and the seat S6 described above will be omitted.

The arm seat A of the eighth embodiment differs from the conveyance seats S1 to S5, the door linings D1 and D2, and the seat S6 mainly in the configuration of a cushion member 810.

The arm seat A is placed on a table T installed on the floor F, and supports the arm of a user from below. Incidentally, the arm seat A is not limited to being placed on the table T, and may be, for example, a cushion placed on the floor F. In addition, the arm seat A may be a cushion placed on a chair installed on the floor F.

### <<Overall Configuration of Seat>>

As shown in FIGS. 34 and 35, the arm seat A of the eighth embodiment is an arm seat, and includes a seat body including the cushion member 810; detection sensors 840 that detect biological signals of a user in contact with the seat body; a display unit 850 that displays the state of the user; and a control device 860 that receives the biological signals detected by the detection sensors 840 and that controls the display unit 850.

The arm seat A is configured by covering the cushion member 810 with a skin material (not shown).

Incidentally, the control device 860 is built inside the cushion member 810, and can also transmit the biological signal to the outside.

### <<Cushion Member>>

As shown in FIG. 34, the cushion member 810 includes a first cushion member 811 containing biomass urethane foam, and a second cushion member 812 that accommodates the first cushion member 811 inside.

As shown in FIG. 34, the first cushion member 811 is disposed below the second cushion member 812, and comes into contact with the second cushion member 812 to overlap the second cushion member 812 in the seat thickness direction.

As shown in FIG. 34, detection sensors 840 are provided on a surface on a user side of the second cushion member 812. Here, the first cushion member 811 is provided at a position different from those of the detection sensors 840. Since the first cushion member 811 is disposed at a position away from the detection sensors 840, deformation of the first cushion member 811 due to the influence of heat or the like generated when the detection sensors 840 are activated can be suppressed.

As shown in FIG. 34, the display unit 850 is connected via a harness 863 to the control device 860 provided in the second cushion member 812. Incidentally, the connection between the control device 860 and the detection sensors 840 is not limited to wired communication through the harness 863, and may be wireless communication.

The display unit 850 is, for example, a liquid crystal display device, an organic EL display device, or the like, and displays a screen based on the biological signal detected by the detection sensors 840. Incidentally, input means such as a keyboard or a mouse may be connected to the cushion member 810. The user can perform an operation such as starting the display on the display unit 850 by operating buttons on a keyboard, a mouse, or the like.

In the present embodiment, the display unit 850 is controlled by the control device 860 built inside the cushion member 810, but is not limited thereto. For example, the display unit 850 may be a mobile terminal such as a tablet inside which the control device 860 is built. In this case, the display unit 850 includes a touch panel as input means, and the user can perform an operation such as starting a game by operating buttons displayed on the display unit 850.

The display unit 850 executes a notification about the state of the user or the presentation or the like of a game and a video according to the detection values of the detection sensors 840. As the detection sensor 840, specifically, in addition to a pressure sensor, a capacitive sensor, a temperature sensor, a sound sensor, an optical sensor, an odor sensor, or the like may be adopted.

It is assumed that for example, in addition to measuring a change in the heart rate of the user and notifying the user of an abnormality in the heart rate (drowsy state), the display unit 850 measures the posture of the user and controls the seat movement of the seat to present a relaxation mode or the like, or presents a game or a video to the user based on biological information (for example, electrocardiogram, blood pressure, body temperature, breathing, or the like) of the user.

Incidentally, notifications, presentations, or the like may be changed by applying weighting to the detection values of the detection sensors 840. In this case, the user can set a weighting coefficient by operating input means such as a touch panel.

Here, the first cushion member 811 is provided at a position different from (a position away from) those of the detection sensors 840. In consequence, deformation of the first cushion member 811 due to the influence of heat or the like generated when the detection sensors 840 are activated can be suppressed.

In such a manner, the second cushion member 812 with high rigidity is disposed to surround the user side of the first cushion member 811 with a low hardness, so that deformation of the first cushion member 811 toward the lower side can be suppressed.

In the above-described embodiment, the first cushion member 811 with a low hardness is disposed at a position far from the user. In consequence, the occurrence that the first cushion member 411 directly receives a load from the seated occupant and thus is deformed can be suppressed.

Further, deformation of the first cushion member 811 due to the influence of the detection sensors 840 can be suppressed.

In the first to fifth embodiments, the conveyance seats used in automobiles have been described as specific examples; however, the present invention is not particularly limited thereto, and the conveyance seats can be used as conveyance seats for airplanes, ships, and the like in addition to conveyance seats for trains, buses, and the like.

In addition, in the sixth embodiment, the door lining used in automobiles has been described as a specific example; however, the present invention is not particularly limited thereto, and the door lining can be used as a conveyance interior member for airplanes, ships, and the like in addition to a conveyance interior member for trains, buses, and the like.

In addition, in the seventh and eighth embodiments, the seat and the arm seat have been described as specific examples; however, the present invention is not particularly limited thereto, and the seat and the arm seat can be used as conveyance seats for automobiles and the like in addition to building interior members installed in buildings and the like.

In the first to eighth embodiments, the conveyance seats, the seat, and the arm seat according to the present invention have been mainly described.

However, the above-described embodiments are merely one example for facilitating understanding of the present invention, and do not limit the present invention. The present invention can be modified and improved without departing from the concept of the present invention, and it goes without saying that the present invention includes its equivalents.

### REFERENCE SIGNS LIST

S1 to S5: conveyance seat (conveyance seat)
   Sa: seat frame
D1, D2: door lining (conveyance interior member)
S6: seat (building interior member)
A: arm seat (building interior member)
1: seat back
   1a: pad material
      1aa: first skin pull-in groove
      1ab: second skin pull-in groove
      1ac: blower accommodating recess
      1ad: ventilation hole
      1ae: bag accommodating recess
      1af: storage recess
   1b: skin material
2: seat cushion
   2a: pad material
      2aa: first skin pull-in groove
      2ab: second skin pull-in groove
      2ac, 2ad: insertion hole
      2ae: ventilation hole
      2af: bag accommodating recess
      2ag: storage recess
   2b: skin material
10: back frame
11: back side frame (side frame)
12: upper frame
13: lower frame
14: connecting frame
15: wire member
16: holding member
20, 120, 220, 320: cushion frame
21, 121: cushion side frame (side frame)
22: pan frame
23, 123: front connecting frame
24, 124: rear connecting frame
30, 130, 230, 330: support member
   30a, 30b: hole
31, 131, 231, 331: support body portion
32: central support portion
   32a, 232a: first central support portion
   32b, 232b: second central support portion
33, 133: side support portion
   33a: first side support portion
   33b: second side support portion
34, 134, 234, 334: shape-holding member (shape-holding wire)
35, 135, 235: front attachment portion
36, 136: rear attachment portion
37, 137: through-hole
38, 138, 238: chuck portion
   38a, 238a: front chuck portion
   38b, 238b: rear chuck portion
239, 339: compression spring
40, 240, 340: detection sensor (seating sensor)
41: sensor detection portion
42: transmission line (conductive wire)
43: connection member (harness)
44: sensor attachment portion
45: vibration device
   45a: upper vibration member
   45b: lower vibration member
   45c: front vibration member
   45d: rear vibration member
50, 250, 350: blower device
51: blower body
52, 252, 352: duct
53, 54: outlet (air blowing port)
55: heat exchange device
56: temperature reduction device
57, 58: ventilation bag
60: control device
61: control unit
62: communication unit
70: rail device
80: height link device
90: reclining device
401: seat back
   401a: pad material
   401b: skin material
402: seat cushion
   402b: skin material
410: cushion member
411: first cushion member
   411a: central body portion
   411b: bulging portion
   411c: ventilation passage
412: second cushion member
   412a: central support portion
   412b: bank portion
   412c: connecting portion
   412d: corner portion
   412e: tear line
   412f: ventilation passage
413: third cushion member
   413a: central portion
   413b: side portion
420: cushion frame (support member)
430: airbag module
440: detection sensor
441: harness
450: blower device
460: control device
461: control unit
462: communication unit
470: temperature adjustment unit
480: notification unit
510: cushion member
511: first cushion member
512: second cushion member
   512a: ventilation passage
513: third cushion member
520: door frame (support member)
540: detection sensor
550: blower device
560: control device
561: control unit
562: communication unit
570: temperature adjustment unit
580: notification unit
610: cushion member
611: first cushion member
   611a: door-side body portion
   611b: armrest bulging portion
612: second cushion member
   612a: door-side support portion
   612b: arm support portion
   612c: ventilation passage
613: third cushion member
620: door frame (support member)
640: detection sensor
650: blower device
660: control device
661: control unit
662: communication unit
670: temperature adjustment unit
680: notification unit
710: cushion member
711: first cushion member
   711a: headrest portion
   711b: backrest portion
   711c: seat portion
   711d: footrest portion
712: second cushion member
   712a: headrest body portion
   712b: backrest body portion
   712c: seat body portion
   712d: footrest body portion
   712e: armrest body portion
   712f: outlet
713: protection cover
720: cushion frame (support member)
721: leg portion
   721a: harness insertion hole
722: placement portion
740: detection sensor
750: blower device
760: control device
761: control unit
762: communication unit
763: harness
770: temperature adjustment unit
810: cushion member
811: first cushion member
812: second cushion member
840: detection sensor
850: display unit
860: control device
861: control unit
862: communication unit
863: harness
P: power supply
R: robot arm
T: table
F: floor
W: wall

1. A conveyance seat, comprising:
a seat frame serving as a skeleton,
wherein the seat frame includes a body frame made of a frame-shaped body, and a support member bridging one portion and the other portion of the body frame in a predetermined direction and supporting a seated occupant, and
the support member includes a central support portion supporting the seated occupant, side support portions provided at positions outside the central support portion in a seat width direction and extending outward in the seat width direction while inclining, and a shape-holding member extending along outer edge portions of the side support portions and bridging the one portion and the other portion of the body frame.

2. The conveyance seat according to claim 1,
wherein the seat frame includes a cushion frame,
the cushion frame includes side frames disposed on right and left sides in the seat width direction as the body frame, a front connecting frame connecting front portions of the right and left side frames, and a rear connecting frame connecting rear portions of the right and left side frames, and
the shape-holding member extends in an elongated manner along the outer edge portions of the side support portions, and bridges the front connecting frame and the rear connecting frame.

3. The conveyance seat according to claim 1,
wherein the central support portion has a mesh shape, and
the side support portions have a mesh shape finer than the mesh shape of the central support portion.

4. The conveyance seat according to claim 1,
wherein the shape-holding member includes an attachment portion attached to the body frame, and
portions of connection locations between the central support portion and the side support portions are disposed outside the attachment portion in the seat width direction.

5. The conveyance seat according to claim 1,
wherein the side support portions extend outward in the seat width direction with respect to the central support portion while inclining to a seated occupant side,
the shape-holding member includes an attachment portion attached to the body frame, and
extension end portions of the side support portions are disposed to be closer to the seated occupant side than the attachment portion.

6. The conveyance seat according to claim 2,
wherein the central support portion has a mesh shape,
a plurality of through-holes penetrating through the central support portion in a direction orthogonal to a support surface of the central support portion are formed at portions of the support surface that do not have the mesh shape, and
the plurality of through-holes are formed to be larger than a mesh of the mesh shape of the central support portion, are provided at predetermined intervals in the seat width direction at central positions on the central support portion, and are disposed at positions overlapping the side support portions in a seat front to rear direction.

7. The conveyance seat according to claim 6,
wherein the shape-holding member includes an attachment portion attached to the body frame, and
the plurality of through-holes are disposed at positions overlapping the attachment portion in the seat width direction.

8. The conveyance seat according to claim 6,
wherein the plurality of through-holes are disposed behind front end portions of the side support portions in the seat front to rear direction.

9. The conveyance seat according to claim 6, further comprising:
a detection sensor that detects a biological signal of the seated occupant,
wherein the detection sensor is disposed between the plurality of through-holes in the seat width direction.

10. The conveyance seat according to claim 9,
wherein the seat frame includes the cushion frame,
the central support portion includes a first central support portion disposed at a central portion of the cushion frame, and right and left second central support portions provided at positions in front of the first central support portion and protruding from right and left side portions of the first central support portion toward a front side,
the shape-holding member extends along outer edges of the central support portion and the side support portions,
the detection sensor includes a sensor attachment portion attached to the shape-holding member, and
the sensor attachment portion is disposed at a position in front of the first central support portion in a top view, and is attached between the right and left second central support portions.
